(19) United States
(12) Patent Application Publication
(10) Pub. No.: US 2011/0303613 A1
(43) Pub. Date: Dec. 15, 2011

(54) Crouse oil spill response process

(76) Inventor: Timothy Christian Crouse, Murray, KY (US)

(21) Appl. No.: 13/134,335

(22) Filed: Jun. 4, 2011

Related U.S. Application Data
(60) Provisional application No. 61/397,214, filed on Jun. 7, 2010.

(51) Int. Cl. E02B 15/04; E02B 15/10; C02F 1/40; E02B 15/06; B01D 17/12; B01D 17/02

(52) U.S. Cl. 210/703; 210/170.05; 210/747.6; 210/170.06; 210/237

(57) ABSTRACT

This is a new oil spill response process made up of a group of new inventions and or technologies that are new to the oil spill response industry. When used in any combination, these new inventions compliment each other forming a new process for cleaning up oil spills. These new inventions can work by themselves, and or they can work with any of the older equipment, techniques, and or processes for cleaning oil spills.

### RELATION TO PRIOR APPLICATION

This non-provisional patent application is based on and claims the benefit of the prior provisional application, U.S. Ser. No. 61/397,214 filed on date: Jun. 7, 2010.

### BACKGROUND OF THE INVENTION

### Field of The Invention

This non-provisional utility patent application is a new process for cleaning up oil spills in any body of water. This process consists of new inventions and vessels applicable to cleaning up oil spills in water. With the new inventions, a large ocean oil spill can be cleaned up more effectively, more efficiently, and in a more environmentally friendly way than by using much of the traditional equipment, processes, and or responses.

### SUMMARY OF INVENTION

This is a non-provisional utility patent application for a new process for cleaning up oil spills in a body of water such as: oceans, rivers, lakes, marshes, swamps, ditches, canals, etc. This process contains several new inventions or parts. Each new invention or ₚart can work and or be applied individually for a oil spill response, but when they are applied in combinations or groups they compliment each other, thus forming a process. Because the inventions making up this process are ‘new inventions’ to oil spill clean-up and or responses, when the inventions are applied in combinations to clean up a oil spill, they make up or form a ‘new’ process for cleaning up oil spills. If used properly the new equipment in this process is capable of actually collecting more oil from the surface of the water than the traditional equipment in several different environments. For this application, the term ‘oil’ will be used to describe oil and or any contaminant having a specific gravity less than 1.0.

Recent spills and mishaps have led to search for new and better methods to clean up oil spills. Current methods simply take too long, are not effective or efficient, and or do little to actually separate the oil from the water. Other tools and equipment currently used, such as dispersant, can actually do more much harm to the environment than they are meant to solve. There are obvious deficiencies in the efforts used to date. Therefore, the need exists for adding new options and better oil spill clean-up equipment. Each new part or piece of equipment in this process can be used as a part of a teamwork style system. Though they can be set up to be used passively, they can also be used aggressively. Used aggressively means that some of the equipment can go and take the oil from the surface of the water instead of just sitting out the equipment and letting the oil get carried by the currents to a formation. The parts are made up of newly invented equipment and vessels; and or there are new uses and designs for old vessels along with new and old technologies, all added and or combined plus organized in a way so it is possible to go and aggressively take the oil from the water in a more efficient and effective way. The overall purpose of this invention and or process, is to do the best possible job of cleaning the oil from the water in the fastest and or best possible way; as well as to complete the process while doing as little harm to the environment as possible. This non-provisional utility patent will describe a process for cleaning oil from water that contains new equipment and technologies useful for: spotting the oil, marking its location, containing or blocking the oil, skimming and collecting; water cleaning; animal and or bird rescue; special equipment for shallow water and sensitive environment suction and collection; etc. The inventions described in this patent application can be used alongside any older or traditional piece of equipment and or with any other previously known techniques and or processes.

### BACKGROUND AND PRIOR ART

One of the traditional or current method and or approaches for the oil clean up process has been to place large ‘containment booms’ out in the water. The ‘containment booms’ are objects which float on top of the water, they are set in formations to direct the flow of oil to collection areas, and act as a barrier between the non-contaminated water and the actual oily or contaminated water. These booms do little to actually separate and or clean the water. The booms are flimsy at best, and they are mostly a passive system that require a lot of man hours to operate. The ‘containment booms’ offer no real or targeted aggressive capabilities. Efforts can be made in using the absorbent booms to extract small amounts of the oil from the water, but once saturated they have to be taken up, cleaned, and replaced; and in big spills it is too much to handle for even a army of responders. The booms do relatively good for visibly showing the spill location over larger areas when looking from the water level or from the air when in place. However, in large ocean spills, the booms have been overrun and rendered basically ineffective due to the waves and normally present ocean conditions which often move the booms way off course so that they break formation, or become beached; thus becoming ineffective.

The second method or approach to the spilled oil has simply been to use the booms to help gather the surface oil into a form or clump, and then perform a method called a ‘controlled burn.’ The controlled burn simply sets the over-contaminated or oily water on fire. The highly concentrated oil contaminant is on the water surface, and it is flammable. The controlled burns are very dangerous, as the enormous amount of oil virtually is surrounding every vessel out in the water. This type of action can easily get out of hand really fast and cause a even larger and more deadly disaster. The burns are also suspected to have caused respiratory ailments to the workers who are working near and around the areas where the burning is occurring.

A third method or approach that has been to date is to building ‘man made islands’ which are meant to separate the oily water from the delicate shorelines, swamps, marsh, etc., as well as to protect some other areas from the oily water. This type of process will be very expensive, and it may cause unknown future problems. There are simply a lot of unknowns and variables associated with this type of relief operation, and the process would be expensive while doing nothing to separate the oil from the water. The process of constructing this would be more costly than building better and new equipment, and the oil would still have to be collected regardless.

The other processes that have been used for past oil spills and similar contamination areas have been to spread human hair, animal hair, and or use other ‘Bio’ materials on the water to absorb or ‘eat’ the oil. Also products like cut grass and hay have been spread on the surface of the water, as well, hoping that they will absorb the oil (and or contaminant). This process works for some contaminants, but this process can simply be overwhelmed by the amount of oil leaked out, and the possible contaminants already present on the actual hay, hair, grasses, etc. such as weed killer or pesticides can often do more damage to the environment than the oil. For spills associated with large amounts of oil or contaminant, there just isn't enough hay and hair on hand to get the job done. Additionally, gathering materials like hair and hay, as well as growing ‘bio’ products in the lab for this reason is enormously expensive, as well as it could potentially cause more problems than it solves in such high amounts. Problems to fish and other ocean habitats would be a factor to deal with when it covers such a large area. Essentially, unknown problems occurring could result in endangering already endangered species thus wiping them out completely. It is best not to use methods such as this in super large quantities. This type of method may be included in this overall process, however, it would be in a more targeted area; and in a smaller scale.

Other options for dispersing the oil have been attempted. Oil companies have used what is referred to as a ‘dispersant’ to contain or control the oil. Dispersants are usually spread by a airplane and or sprayed from ships. Dispersants are usually a liquid soap or other types of chemicals which can mend to the oil so that the oil forms clumps. The clumps then sink below the surface so that visibly on the surface, the problem looks as if it has been solved, and the mess doesn't look so bad to the reporters filming the area. In the case for the deep ocean wells most common off the coastline of the United States, in the Gulf area (such as the where the deep ocean well platforms are located) the water surrounding the area is so deep that the chimps only fall below the surface to a certain point. Then, because of the high possible amounts of oil and dispersant mixed, it can get into the fish habitat areas and possibly other reefs, wetlands, breeding areas, rivers entrances, swamps, etc. This can then cause more harm than the actual oil itself, had it all just been left alone. The chemicals used for the dispersants have also been known to cause respiratory ailments in the workers surrounding areas where the dispersants have been spread. In previous spills, in the areas where the dispersants have been spread, the surface evaporation has caused the chemicals to rise up in the air in which the workers are breathing. This has sent workers to the hospital, and it has led to the workers having to wear actual gas masks as they work in the heat cleaning up the water. There are many unknowns related to the dispersants. Some of the unknowns are the current, short, medium, and long term effects of the chemicals on the fish and or any wetlands in the regions. Because the dispersants are usually spread by airplanes, there are also concerns for the birds and other flying species in the area as well.

In some cases, even with the new process and equipment, any of the old listed techniques or equipment will still be a option. Skimming techs and or equipment have also been used, and skimming is still needed and very useful. The skimming techs usually consist of using deeper hulled vessels and trolling with or pulling a ‘J shaped’ Boom, ‘V shaped’ boom, or ‘teardrop shaped’ boom so that the booms help funnel the oil at the base of the (for example) ‘V’; and then the oil is suctioned out using some kind of throw pump which is tossed by the crew into the boom area. The pump sucks the oil from the water into containers in or on the vessels. Skimming is a good and often environmentally friendly way to clean the oil from the surface, however with the current vessels there are some places that the booming cannot be done or operate in due to the deeper hulls on the vessels. Also, there is a limited amount of oil that each vessels can take in. When large spills happen, it often calls for hundreds of ships to skim for oil. New types of skimming vessels are needed that can take in more oil. And, new vessels and or new equipment are needed that have more shallow drafts which allows them go into more shallow waters, environmentally sensitive areas, and or swamps, marshes, near shoreline and shoreline areas, etc. to get pockets of oil. Additionally, the large super skimmers have too deep of a draft, and because of it they are not as effective in certain areas. The deep hulled and deep draft super skimmers are often used with a intake in the front where they take a big ‘gulp’ of the incoming oil and then the oil falls or is suctioned, etc. into collection tanks inside the vessel. These super skimmer can hold a tremendous amount of oil, but they are difficult to maneuver and they are dangerous to other vessels in the area This non-provisional patent application will show better more suited vessels which can hold large amounts of oil, they have similar intake ability, but they are more nimble and can even go in shallow waters.

### BRIEF DESCRIPTIONS OF THE DRAWINGS

DRAWING 1 Shows a overhead and angled side view which shows Spotting vessels in space, in air, and on sea or water. The vessels are: a satellite 703; drone helicopter 601; drone airplanes or jet 603; a blimp 602 (can be unmanned or manned). Also vessel 300 pulling netting 405 A and B with or in the net frames 401. A and B.

DRAWING 2 Shows a overhead and side angled view which shows high altitude or space vessels which are satellites 703 (A) and (B) providing GPS ability to water going vessels cleaning up the Oil spill 101, such as: Barge Skimmer 107; vessel 300 (C) trolling with Nets 405 inside Net Frames 401; and vessels 300 (A) and (B) pulling a super large Net 405 (A) having a super large Net Frame opening 401 (A).

DRAWING 3 Shows a overhead view of a vessel 300 in the water, resembling a shrimp boat, pulling Nets 405 A and B and net frames 401 A and B through the water.

DRAWING 4 is a super up-close magnified and or ‘exploded’ view showing the weaving or porous nature of a cut out piece of material making up the Netting 405. The Netting 405 is shown with water passing through the pores of the weaving from left to right while the oil being stopped or prevented from passing. The pores in the weaving are too small for the oil to pass through, but they are large enough for the water to pass through.

DRAWING 5 Is a overhead front left side view of vessel 300 as it would be in the water and trolling from right to left using one of the many possible trolling techniques using boom and or hoist 402 holding one of the many possible designs for a Netting 405 plus Net Frame 401 skimming system; while the vessel 300 is also pulling two Nets 405 (A) and (B) which are cinched and already filled with oil.

DRAWING 6 Is a up close, semi overhead, front, and angled side view of one of the many possible sizes of a Net or Netting 405, this one is a close up view resembling a trash bag, by itself, and without any Net Frame present (also drawn out of the water). The opening of the Net 405 is visible.

DRAWING 7 Is another version of many possible sizes and shapes of a Net 405, but this one is inside a Net Frame 401. The Net 405 in Net Frame 401 is drawn with a up close, angled front left side view. The opening of Net 405 and Net Frame 401 is visible. (drawn out of the water).

DRAWING 8 Shows a up close semi front and angled left side view of another versions of a Net Frame 401, this is a smaller skim net frame (without a net), by itself, and this version resembles a ‘crab trap.’ The opening of the Net Frame 401 is on the left side of the page (drawn out of the water).

DRAWING 9 Shows a left side view of the larger vessel 300 (A) in the water as it would be going from right to left, and it is shown hoisting 402 a filled Net 405 out of the water. Also in the drawing is a overhead view of the smaller vessel 300 (B) as it would be, in the water and moving toward the larger vessel to off-load the filled nets 405 that it is pulling (all filled nets are using the same 405 number in this drawing).

DRAWING 10 Shows a overhead angled front and right side view of two. vessels 300 (A) and (B) in the water, as they would be moving from left to right, and pulling a large Net 405 through and in the water. The vessels also have booms 777 (A) and (B) attached one to each vessel and preceding the Net 405 opening so that they are used to funnel a larger surface area of oil into the net.

DRAWING 11 Shows a left water line and below water line see-through view of the basic version of a single and lone Barge Skimming vessel 107 as if the barge skimmer would be moving from right to left. This drawing shows a protruding Front End rigging 111 has been added to the barge skimmer, and the Oil Intake Area 110 is where the oil enters. The drawing also shows that this Barge Skimmer 107 only has one internal tank 120 inside the vessel (they can have several tanks). It show what has been skimmed or collected inside the main Barge Holding Tank 120 and after oil 101 has been collected and inside the tank so that the tank is about 3/4 full. The inside of the tank shows that the Oil 101 has naturally risen to the top of the Water 102; it shows the amount of water 102 at the bottom of the tank, as well as a piping or hose 150 going from the bottom of the tank, up, and out to the barge deck; and it shows a Drain 151 connected to Hose 150 so that when the Drain 151 is opened, just the water 102 would get drained out through pipe 150 and Drain 151 first, and the water is let out back into the sea.

DRAWING 12 Shows a overhead angled front view of two vessels 300(A) and (B) as they would be in the water and pulling a large barge skimmer 107 vessel, using booms 777 (A) and (B) through the water 102 towards a oil slick 101. This Barge Skimmer 107 has three holding tanks 120 (A), (B), and (C), along with piping or hoses 150, and other optional equipment added to clean or separate the oil from the water once collected, such as generators 106, vacuums 104, and oil centrifuge equipment 105.

DRAWING 13 Shows a overhead angled left side view of the super tanker 308 (A) in the water and suctioning oil from the last barge 107 (C) of a water/oil cleaning Station 200 out in the water ; and the drawing shows a Barge Skimmer 107 (D) being pushed by a tugboat vessel 300 (B) through the water from right to left.

DRAWING 14 Shows a overhead left rear angled view of a line-up of large to small barge skimming vessels 107 A, B, C, D, E. This drawing shows that the Barge Skimmers can come in different sizes, and it shows that they can have optional hulls, such as 107 (C); and this shows that the Barge Skimmer can also have their own propulsion systems, with some example shown at 109 A, B, and C.

DRAWING 15 Shows a overhead left front angled view of a barge skimmer 107 as in the water going from right to left. This Barge Skimmer has a protruding front end rigging 111, a large intake area 110, hoses 150; drains 151, extra holding tanks 120 A, as well as added equipment options for separating the oil and water inside the tanks and at collection, such as Generators 106, Vacuum Units 104, and Oil Centrifuge Machines 105.

DRAWING 16 Shows a left side see-through view of a Oil/Water Checking Tube 802. This shows the Checking Tube bottom 801, water in the tube 102, and water oil mixed area 205 in the tube, and a oil layer at the top 101 in the tube. The Checking up end is capped with a hose 150 coming from it and attached to a valve 804 and pump 803.

DRAWING 17 Shows a overhead view of a barge skimmer 107 in the water as it would be moving from right to left, or stationary facing the left, with conveyor belts 510, with pressure sprayers 161, and pressure sprayer attachments 162; and while a worker 608 uses a squeegee 407 to help get the oil 101 onto the belt and out of the water 102, and into the barge tank 120.

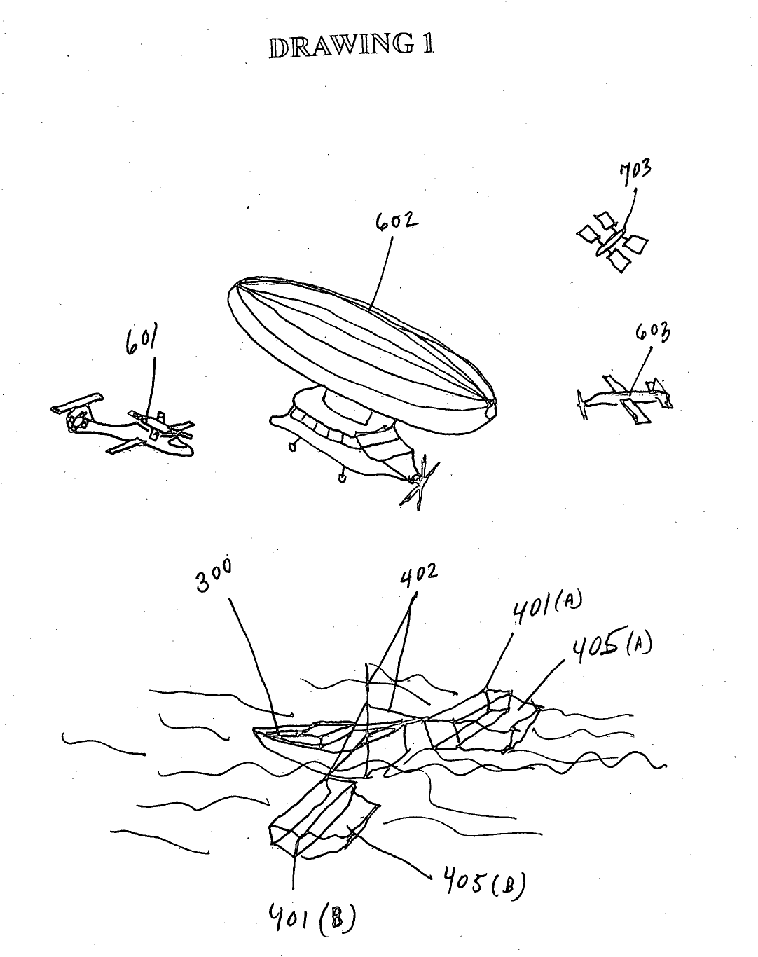

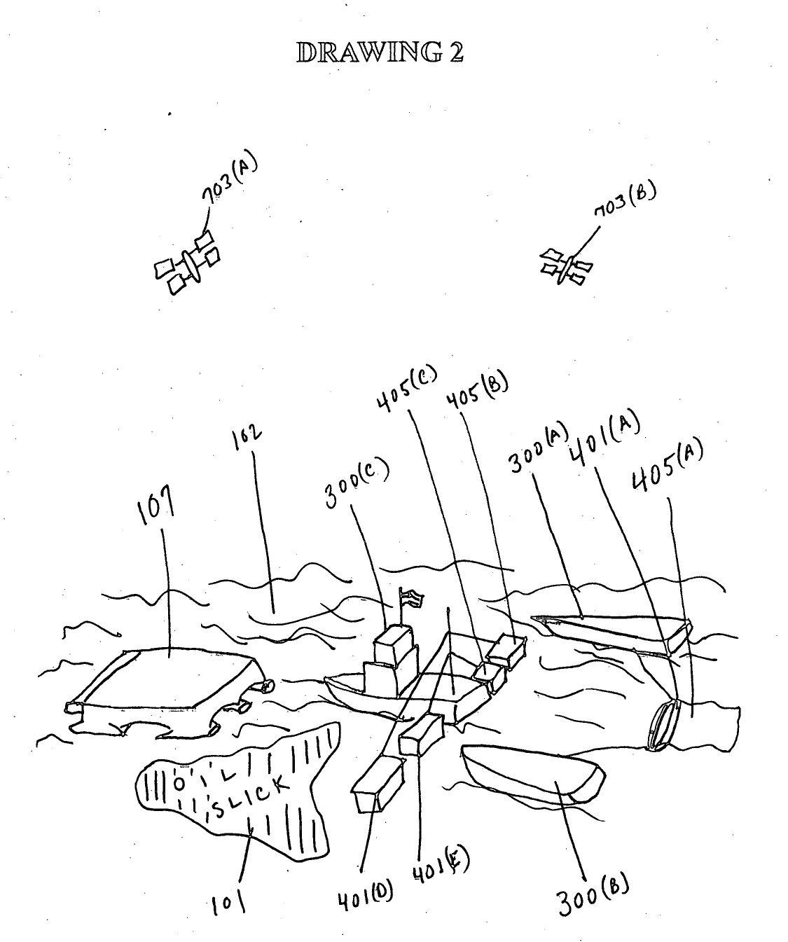

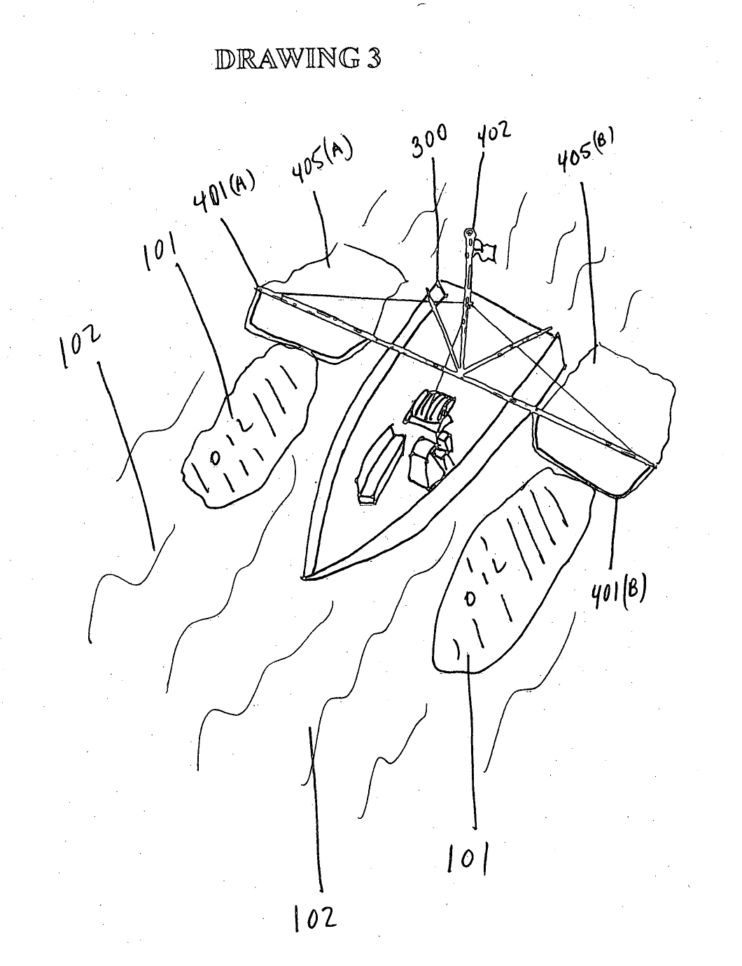

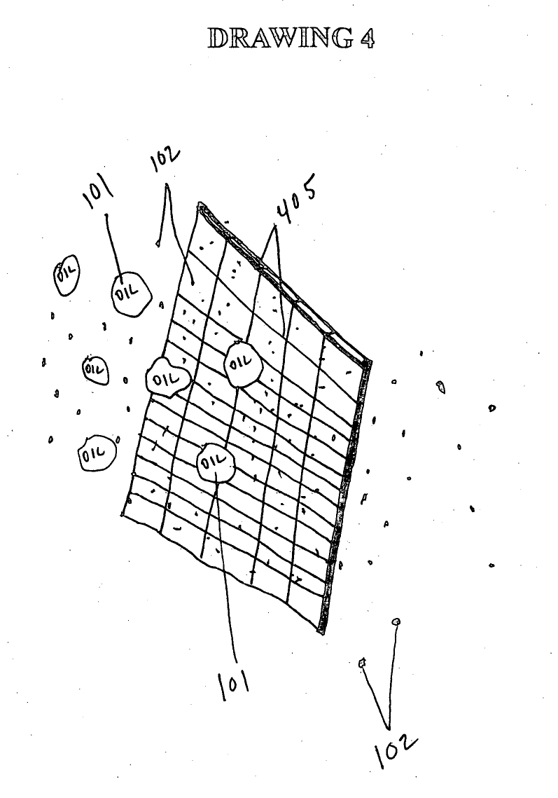

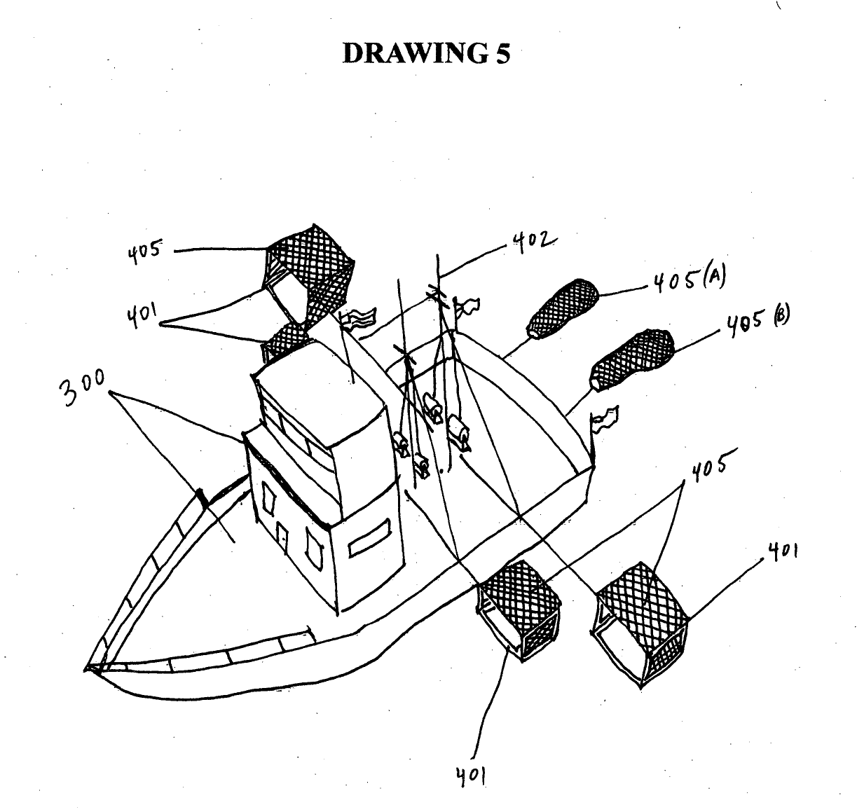

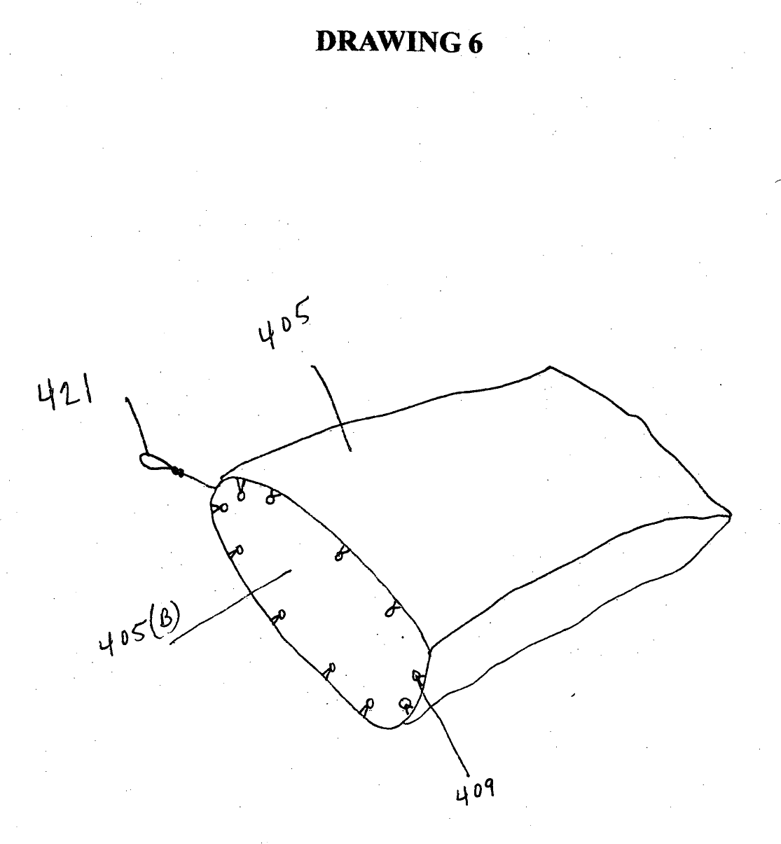

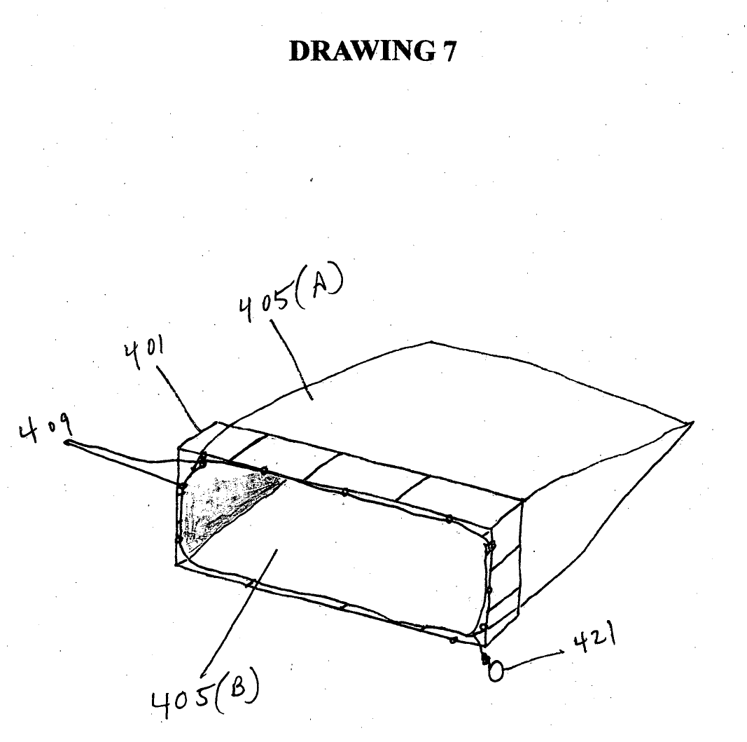

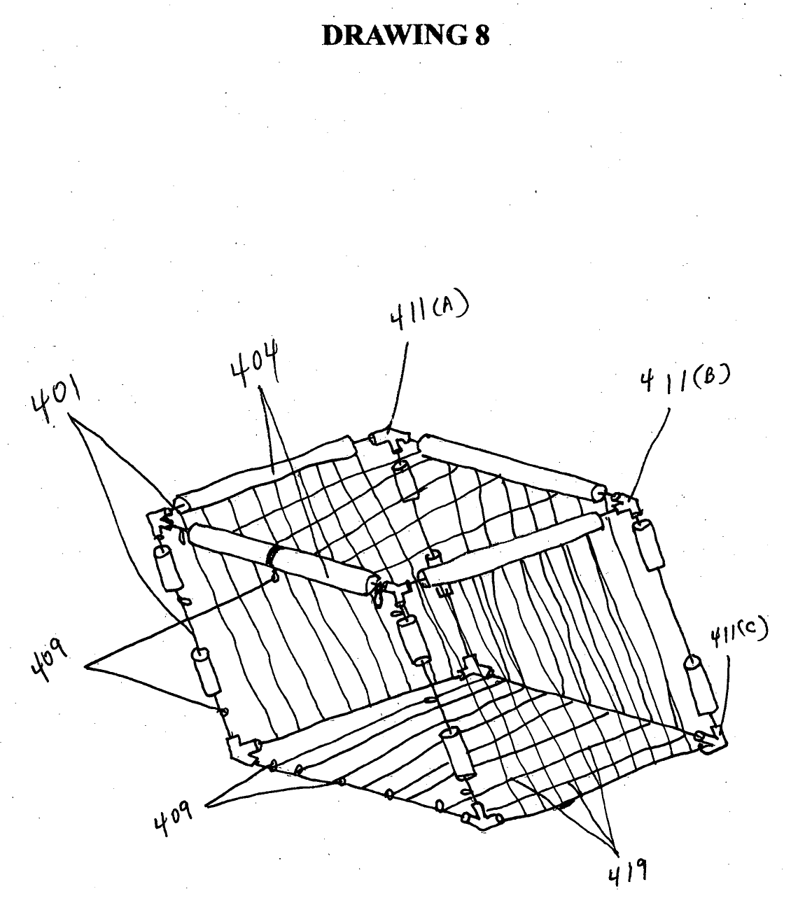

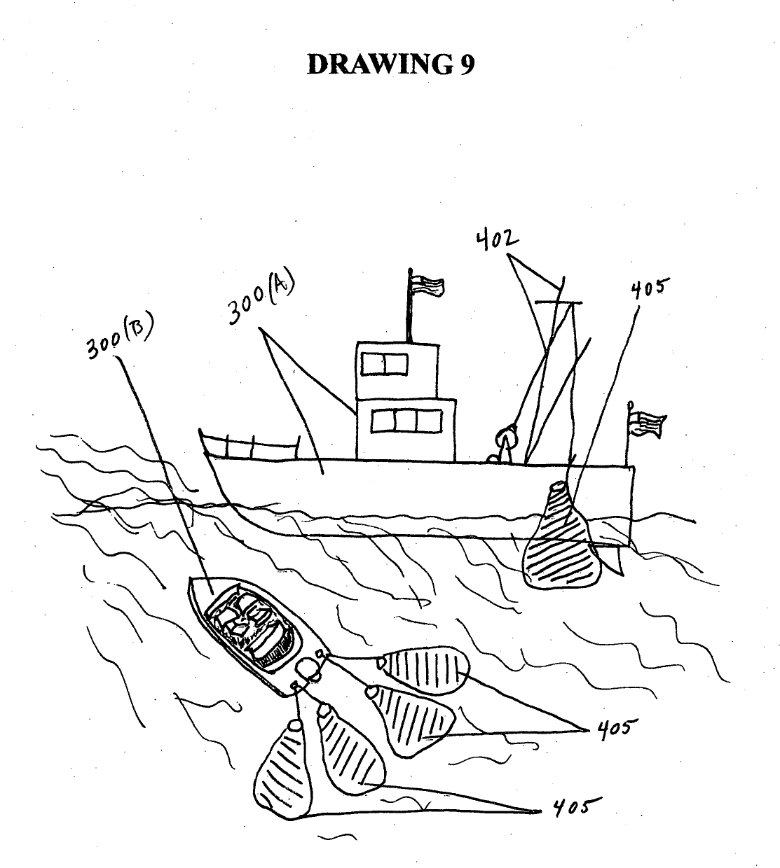

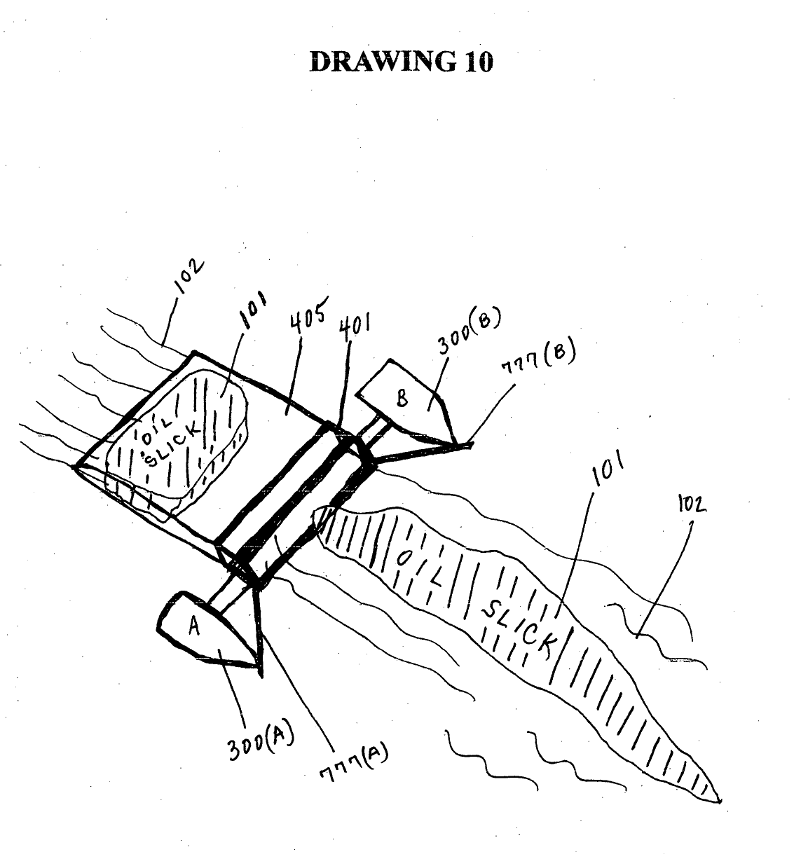

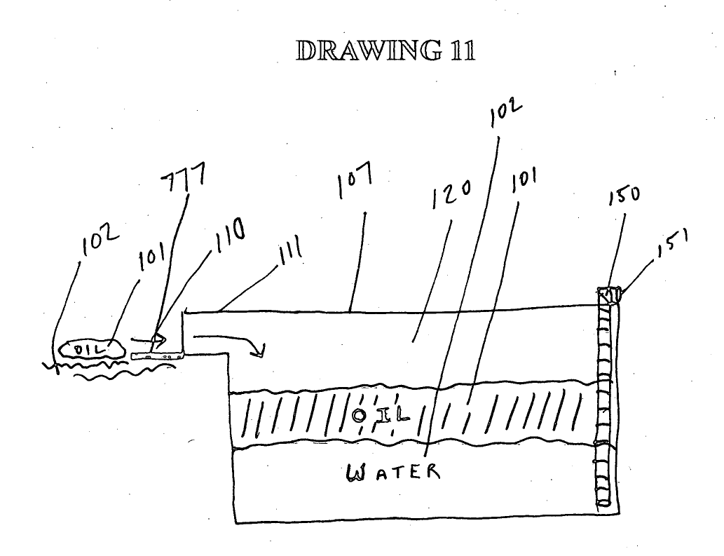

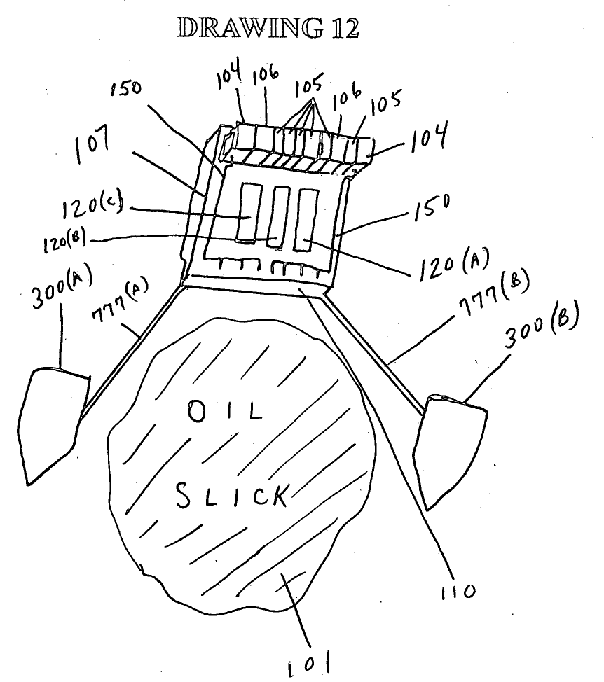

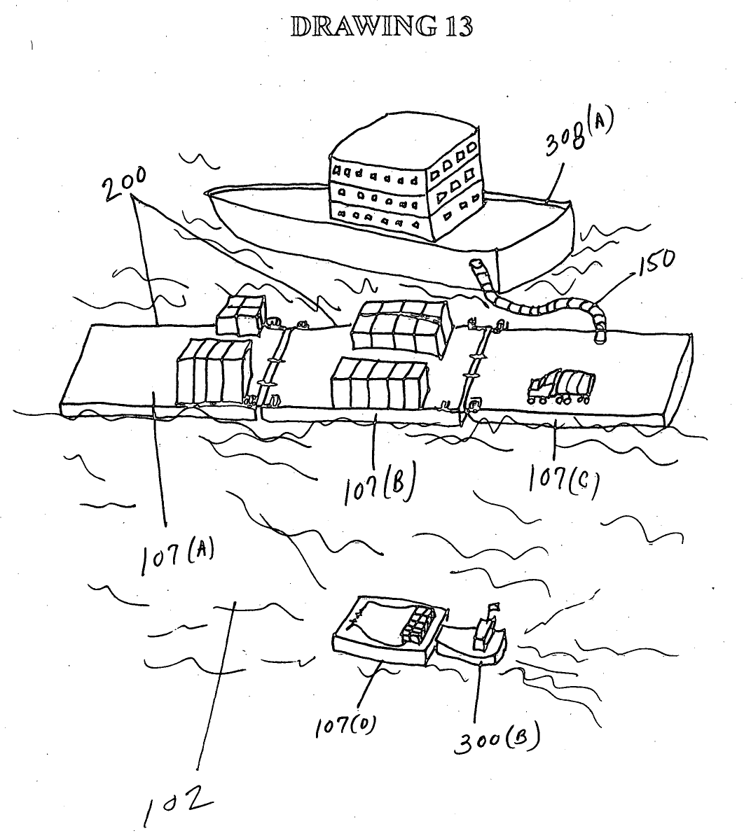

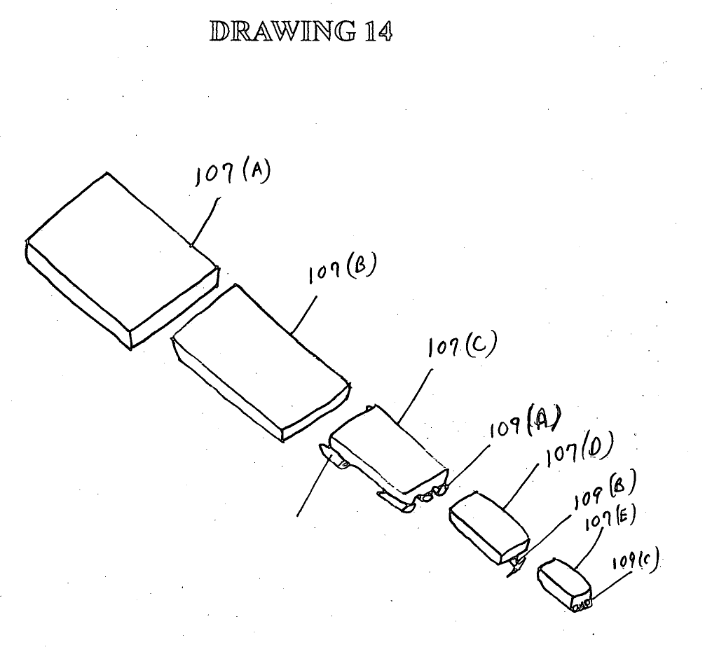

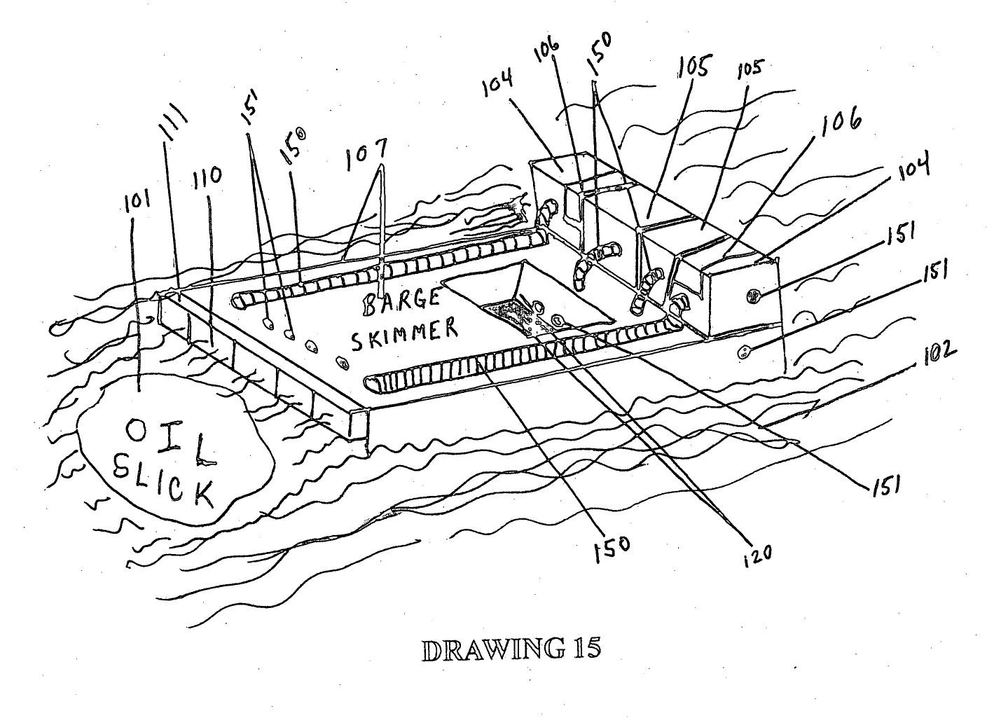

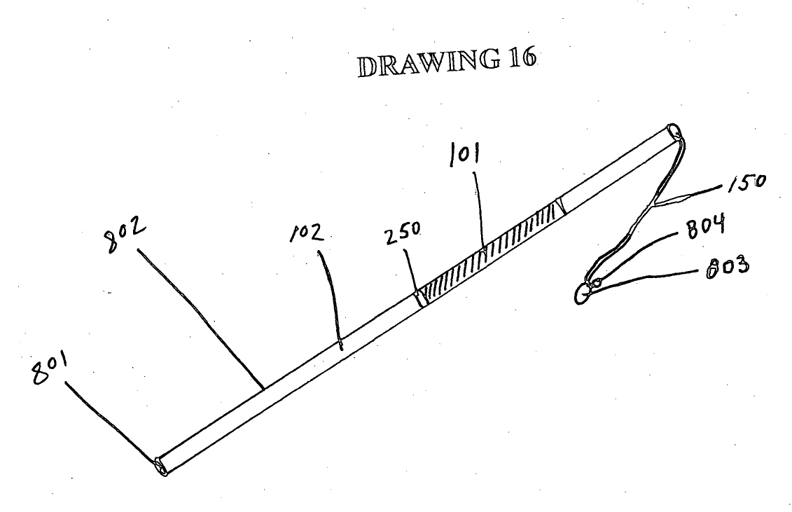

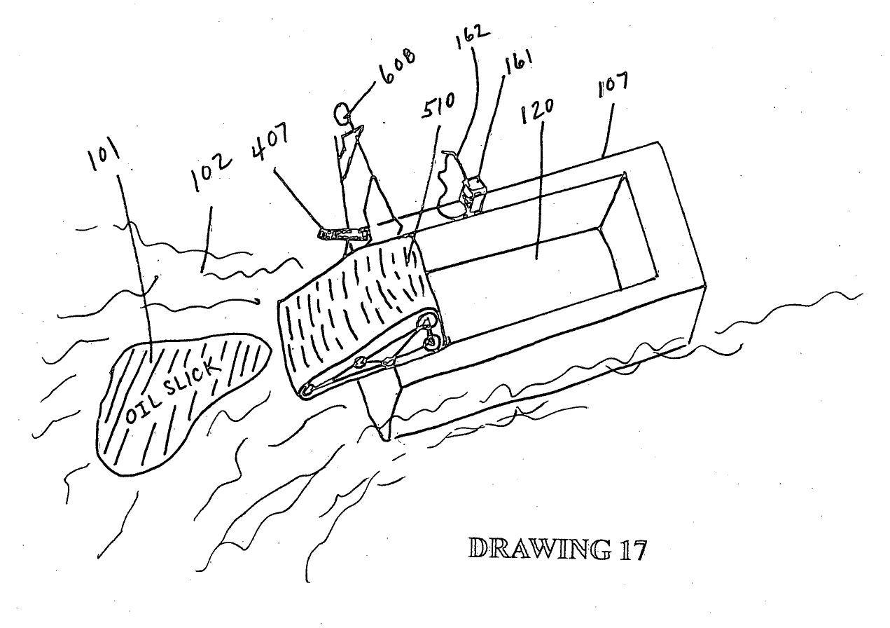

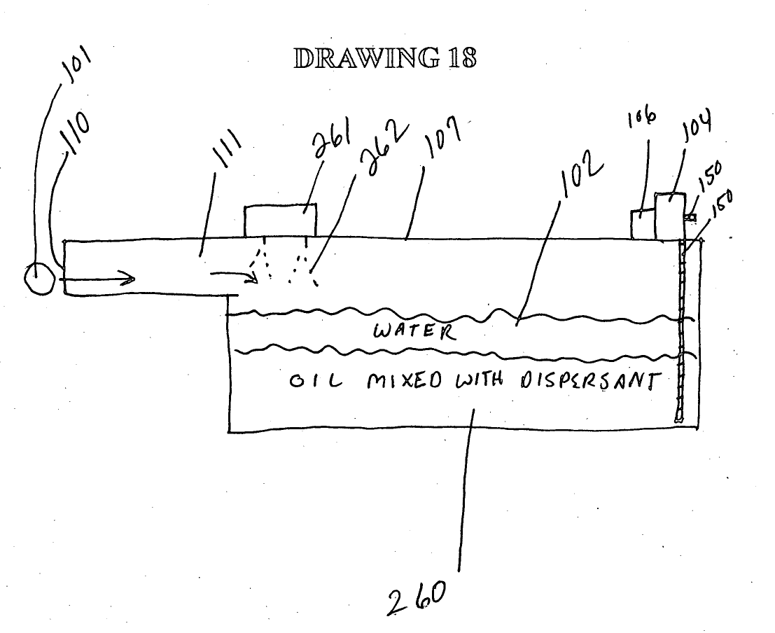

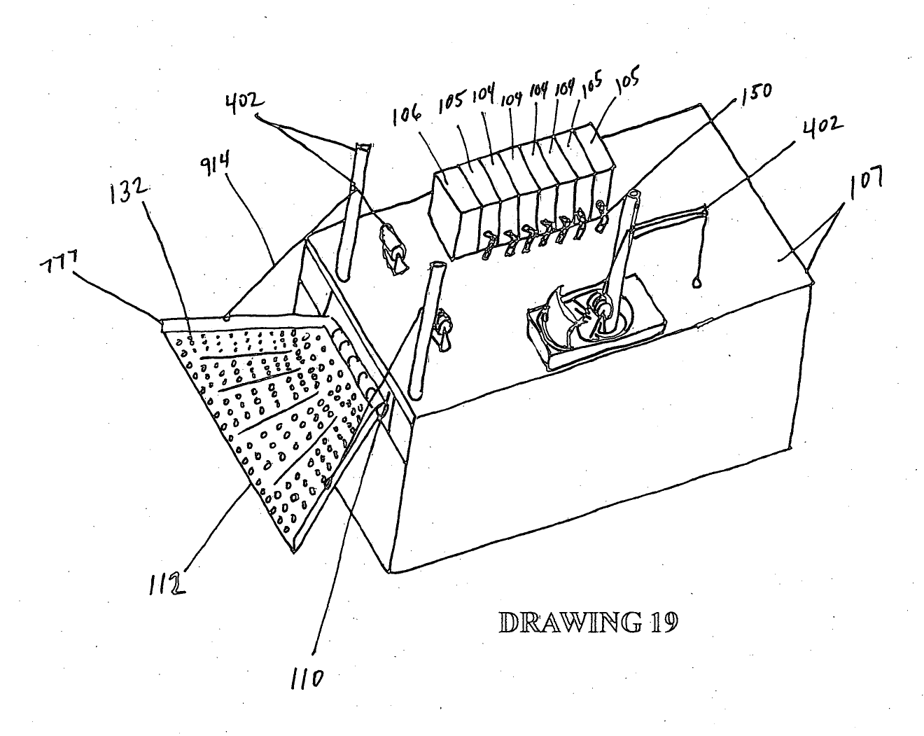

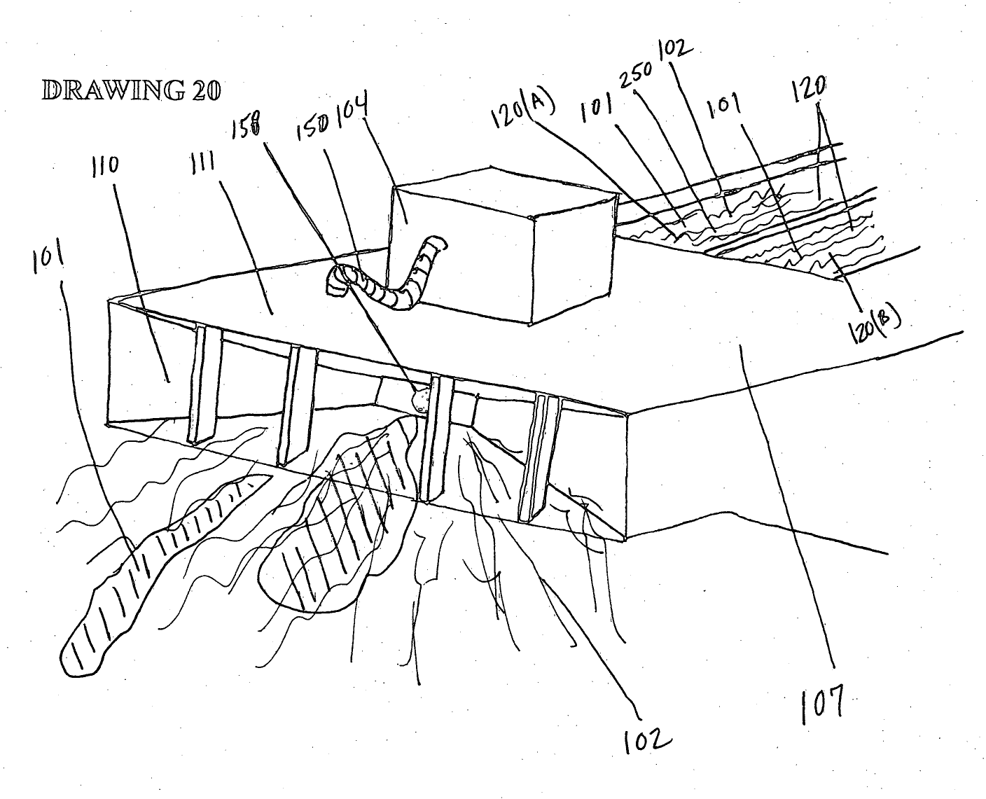

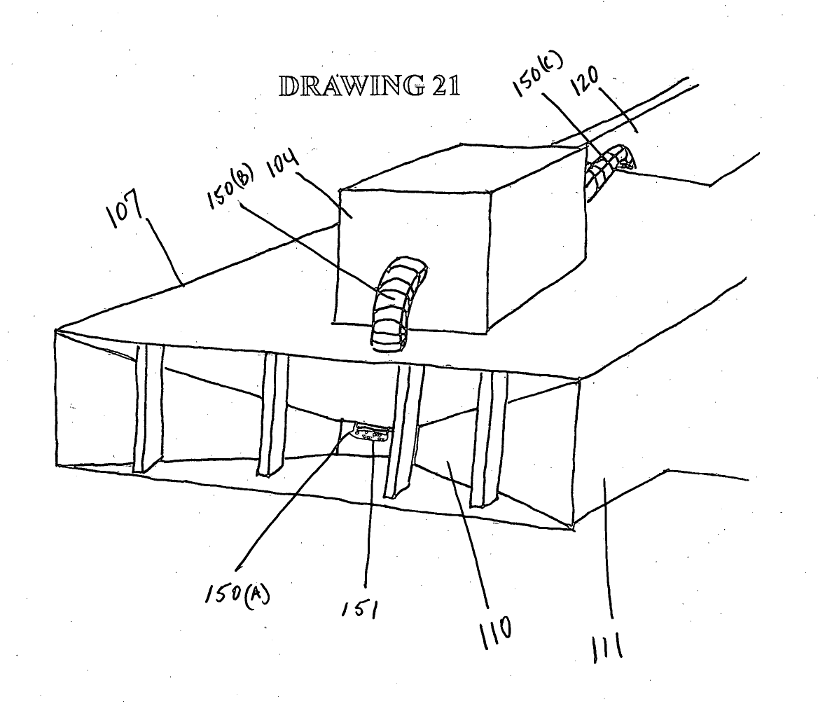

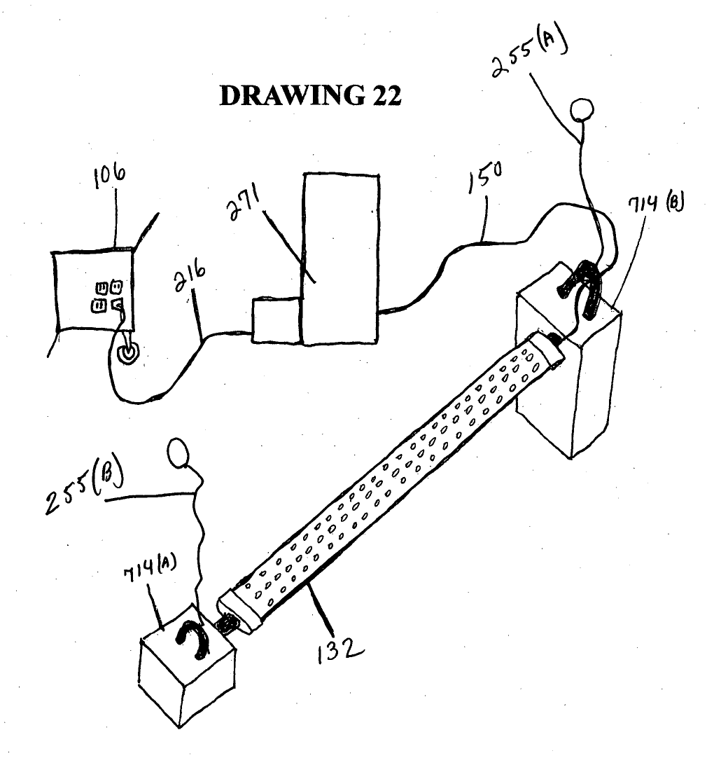

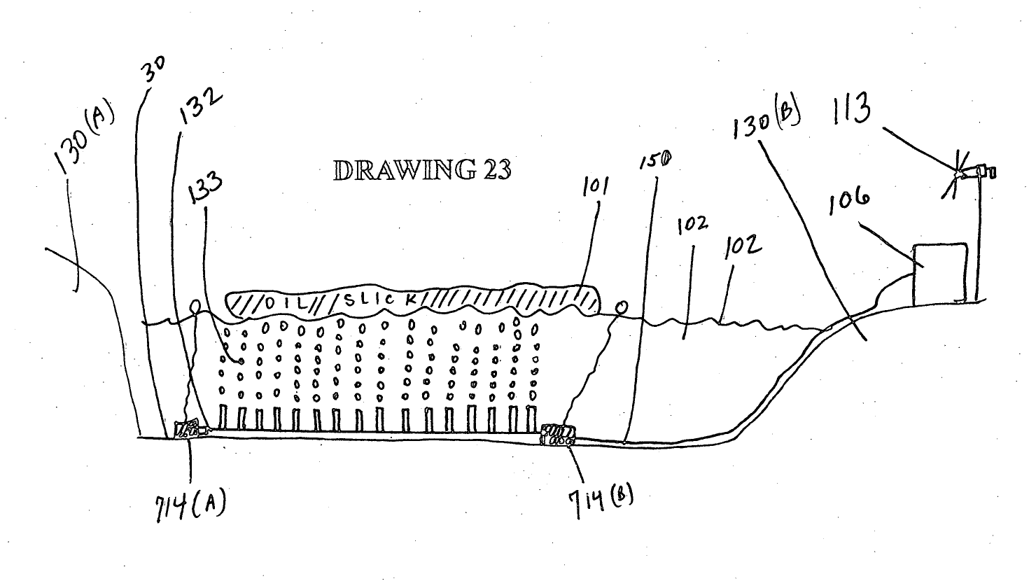

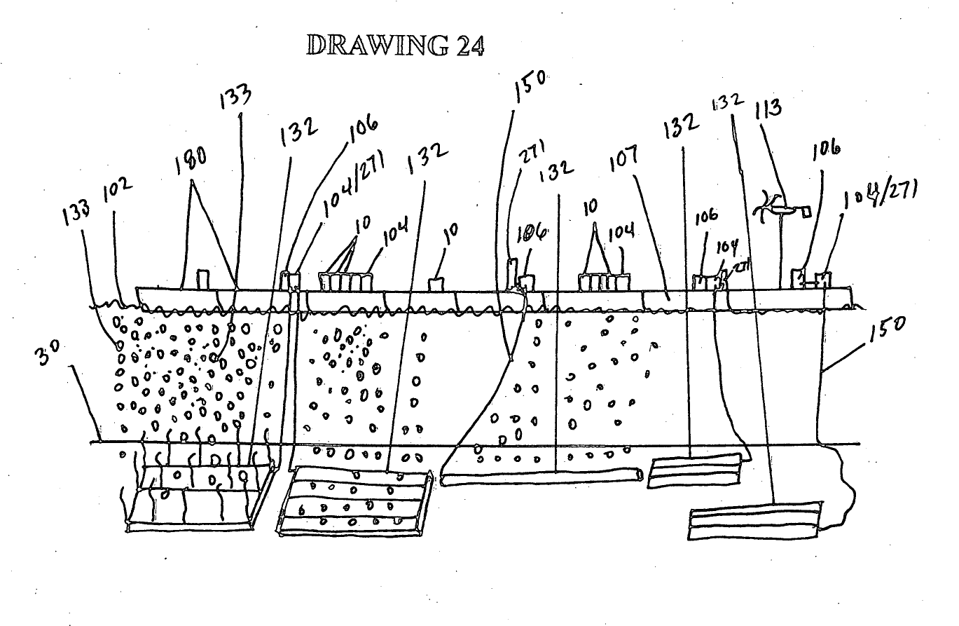

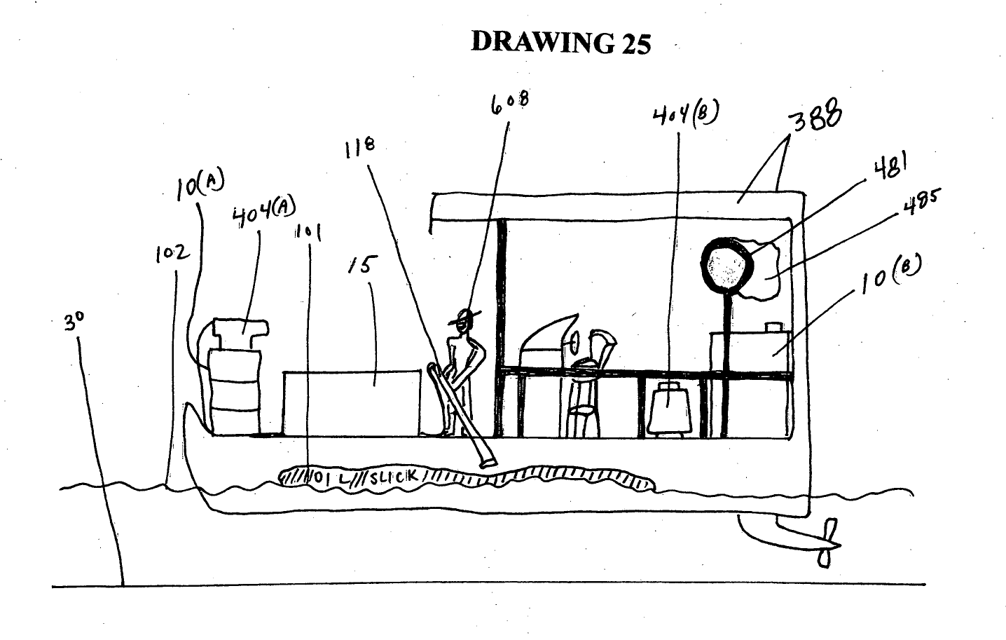

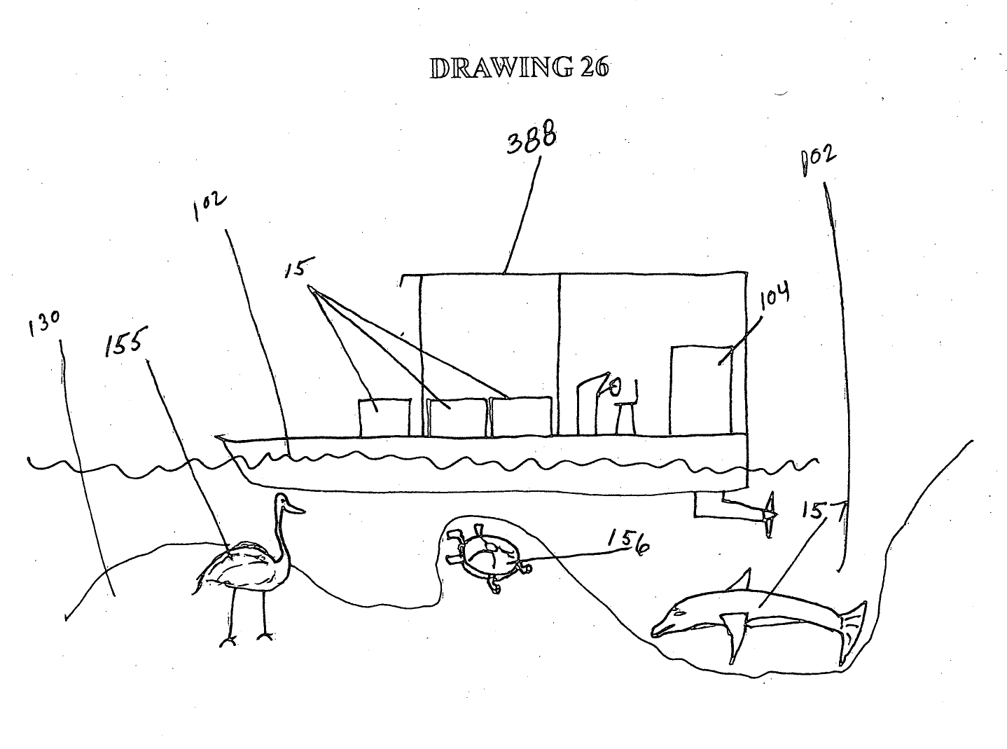

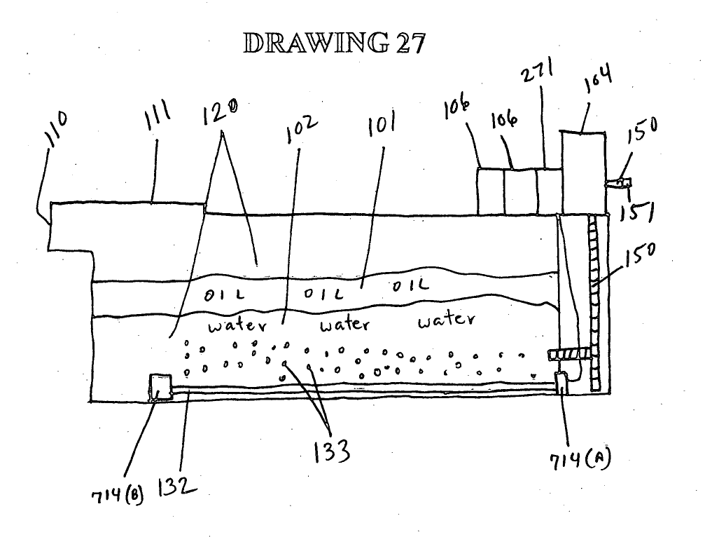

DRAWING 18 Shows a see-through left side view of a barge skimmer 107 having a similar working as in drawing/figure 11; but added to this barge skimmer is equipment for separating the oil from water a different way than the previous methods show. A sprayer 261 spraying a dispersant or other bio product 262 into the tank 120 where the collected oil and water is located. The spray 262 makes the oil mixed with the sprayed material/liquid/etc. 260 go to the bottom of the tank while the cleaner water 102 would then come to the top. Generators 106, hoses 150, and vacuum equipment are added as well.

DRAWING 19 Shows a overhead front left side view of a barge skimmer 107 as it would be in the water going from right to left, with a added optional wedge-shaped 112 front end, along with other equipment added to the deck, such as: hoists 402, generators 106, oil centrifuges 105, vacuums 104, booms 777, and hoses/pipes 150.

DRAWING 20 Shows a water level front view as if looking into the front end 111 of a Barge Skimming Vessel 107 intake area 110 from the front and somewhat to the left. Visible is the bulkhead and intake piping 158 where the oil is funneled into the skimmer. On the top deck is a vacuum 104 attached to hose 150 sucking/pumping the oil front the intake to the rear holding tanks 120 A and B.

DRAWING 21 Shows a water level front view as if looking into the front end 111 of a Barge Skimming Vessel 107 intake area 110 from the front and somewhat to the left. Visible is a vacuum 104 on the deck with a hose/pipe 150 (A) and hose/pipe opening 151 extending down into the bulkhead or intake area and suctioning oil from the top of the water and into a rear tank 120.

DRAWING 22 Shows a example of a Air Bubble Barrier Pipe 132 set up. This shows one way to make the Air Bubble Barrier work. The generator 106 is providing power to the air compressor 271, and the compressor is pumping air through the hose 150, into the Air pipe 132, which is anchored by blocks 714 A and B. The system is lowered by ropes 255 (A) and (B) connected to the blocks.

DRAWING 23 Shows a water line and under the water line see through the water side view of one styles of a Air Bubble Pipe system 132 (all have same number) lying on the floor of a Bay and then shooting a Air Bubbles Wall 133 from under the oil 101 and water 102 up from the bay floor. Both sides of the Bay are marked a 130 A and B. Generator 106 and Windmill 113 are powering a aeration or air pumping system (not shown) with the hose 150 taking the air to the Air Bubble Pipes 132. The blocks 714 A and B are holding the Air Pipes 132 in place and on the ocean or Bay floor.

DRAWING 24 Shows a side, water line, and see through the water line to the ocean floor view of a plurality of different styles of Air Bubble Pipe systems 132, which are forming a Air Bubble Barrier 133 in the water by shooting air bubbles to the surface from under one side of a Barge Barrier 180. On the decks of the Barge Barrier is the equipment that is generators 106, vacuums 104, vacuum/pumps 104/271, compressors 271, windmills 113, oil collection containers 10, as well as the hoses or piping 150 getting air to the Air Bubble Piping.

DRAWING 25 Shows a left side water line and see through the water view of a super shallow draft smaller Mobile Cleaning Station Vessel 388, having a Cleaning Station 15 on it. The vessel is in the water 102, and on it is a man 608 holding/using the suction attachment 188 connected to the smaller suction equipment 404 (A) on a 55 gallon drum or barrel container 10 (A). Also on the vessel is a ‘Shop Vac’ brand 404 (B) wet/dry vacuum for suctioning oil, as well as extra containers 10 (B) for holding the suctioned oil 101, or fresh water, or fuel, etc. A small Scoop Net 485 connected to a Scoop Pole 481 is there for scooping wildlife from oil situations. Also on the vessel is a animal/bird/reptile/etc. cleaning station 15 for cleaning the birds or animal which may be soaked with oil.

DRAWING 26 Shows a left side water line and see through the water line view of a smaller shallow draft vessel 388, in the water 102, with a vacuum 104 in the rear and on the front is a Cleaning Station 15 for cleaning the birds and animals that may be found sitting on booms, in the oil 101, etc. This is a Mobile Cleaning Vessel 388. Also, this shows a released and cleaned bird 155, a turtle 156 laying on the bank 130, and a dolphin 157 in the water 102.

DRAWING 27 Shows a see-through version of the left side of one option for adding additional equipment to a barge skimmer 107. This Barge skimmer 107 has added a air bubble pipe techs 132 to and or at the bottom of its main holding tank 120, so that it shoots a Air Bubble Barrier 133, with air supplied by the compressor 271 connected by hoses 150 under the collected oil 101 and water 102 mixed so that the air bubbles 133 are pushing the oil 101 to the top helping to separate the water 102 from the oil so that only clean water is at the bottom of the tank; and then pipes/hoses 150 connected to the drain 151 pumped by vacuum/pump unit 104 on the deck of the barge and powered by generator 106, pumps out the cleaner water from the bottom of the holding tank through pipe 150 out drain 151; thus making the holding tanks have mainly oil inside them to increase skimming efficiency.

### DETAILED DESCRIPTION OF THE PREFERRED EMBODIMENTS

This utility patent application is for a oil spill clean-up and or response process. This new process made up several new inventions. Each new invention listed in this application is a new tool for use in the oil spill clean-up and or response industry. When you put any of the new inventions listed in this patent application together, they compliment each other in a way so that they form a patentable oil spill clean-up process. New more effective and efficient products are desperately needed for responding to and cleaning up oil spills, especially deep ocean spills where many active oil wells and or oil platforms are located. The listed inventions are capable of doing this.

Each individual new invention making up this process consists of a new use, design, and or applications for several existing technologies, vessels, and or pieces of equipment that have uses and or applications in other industries. Each part has been put together in a patentable way for a desired use or application in cleaning up oil spills. When responding to a large ocean spill, there is opportunity that all the new inventions would be deployed at once, although-they don't always have to be. For smaller spills, all the equipment may not be necessary. Because all the individual parts or pieces making up this process are all new inventions new to oil spill response, when any part is used in any combination, this means that this process is being used.

The parts or new inventions making up this process takes technologies, materials, equipment, vessels, etc. from other business areas and then combines them in a strategic way, (in some cases with new designs) so that they create oil spill clean-up equipment suited for specific or multiple tasks. Because some of the equipment, vessels, and or technologies may have a known existing use or function outside the oil spill industry, it is not necessary to discuss how each of those technologies work; as anyone-knowledgeable about those specific technologies would understand how they work or function. Because some of the vessels and equipment have been used in other industries before, the descriptions and or drawings will describe and or present them for how they will be put together or used in a applicable way for the oil spill clean-up industry only. In some drawings or descriptions, the size and scale options are areas that will be discussed, but the drawings will not be to any certain scale. Some of the drawings in this patent application are meant to show or represent certain situations where the technologies, vessels, and or new inventions described would or could be applied in real oil spill response situations. The drawings or descriptions will ‘not’ state or show ‘every way’ the techs can be designed, used, or applied; nor with they show ‘all’ the equipment options that they might be added.

The Spill Coordinator would have the option of using any of the listed equipment in any way usable or suitable for cleaning up a oil spill. The option always exists for adding any new piece of equipment or technology to the vessels in this process to make them better or more efficient. Any new invention presented for use in this process can be used alongside or with any older technology, technique, and or with any existing response process, etc.

Some of the drawings are meant to show the applicable utility of each invention, while others show new designs, etc. Some of the drawings will show how the same vessels can be made or designed a few different ways; and they will show different riggings and or equipment added. Some of the vessels can be tailored for desired efficiency ratings by having more, less, or slightly different equipment added. The equipment added may perform different tasks, so that the vessel the equipment was added to produces a slightly different result, but a specific desired outcome. This is especially so for the barge skimmers 107. The equipment also can be made in many different shaped, styles, and or size options. For example, the Nets 405 and Net Frames 401, will be shown in drawings in several shapes, sizes, and with different vessels. The different drawings showing the many options for Net 405 and Net Frame 401 size, shape, etc., are meant to show the applicable versatility and ability to tailor the Netting, Net Frames, and even Barge Skimmers for specific uses; and or for different areas where spills may be located, and or for different size spills.

One huge advantage of the equipment and or inventions presented in this non-provisional utility patent application, is that many of the inventions (or utility of) can be rigged, be repaired, or even created entirely using materials commonly available at the shipyards, docks, and facilities within several miles of the area where the oil is being spilled. The vessels discussed in this application are usually present and or available in or near those areas where spills occur anyway. Many fish, shrimp, crab fishermen, etc. may be out of work because of the spill, so the owners of the vessels could be employed to help clean up the spill by adding some of the Nets 405 and Net Frames 401, discussed and shown in the drawings in this application, to their vessels. Additionally, the riggings plus equipment that can be added to the vessels, described and in the drawings, can be done on sight by workers relatively easy. The vessels discussed in this application show the vessels that are usually present in or near any shipyard or docking area. The inventions such as the barge designs with front end riggings and intake ability can easily be built on site, rigged, and or added to the barge in a way so that they can be created and deployed in very little time. The extra equipment such as the generators 106, vacuums 104, containers 10, centrifuge equipment 105, hoists or lifts 402, Air Bubble Pipes 132, etc. are usually equipment that can easily be purchased in the surrounding area or shipped in quickly and then attached, plumbed in, or affixed to a barge deck, etc. All the ‘extra’ added equipment can work together using simple cords, hoses 150, and or plumbing techniques. Many barges come with single, double, triple, or sometimes more internal or external tank areas, therefore the designs can vary for using the many barge options. Used barges can be purchased and easily rigged and or converted if more are needed. Because the barges can come with or have different numbers of internal or external holding tanks, it creates the ability to use each tank in a way so that with a few pipes and a little plumbing added, can help in the separation of oil and water after it is collected or skimmed. The barge tanks can easily be plumbed or rigged so that the technique shown in the drawings and discussed in this application can be used.

This response process does not give a specific number of pieces or equipment needed for a certain size spill, but it will hopefully set in place a better way to determine a specific number in terms of vessels/skimmers needed per well output. This is a area than can be better further researched and determined due to the effectiveness and efficiency of the new measuring equipment and skimming vessels that will be discussed and described later in this process (especially the Barge Skimmers . . . shown as 107 in the drawings).

This process consists of new inventions, and the new inventions are simply: the measuring device capable of measuring the oil and water layers inside the collection tanks of the barge skimmers; the barge skimmers, all represented by number 107 having one or more internal tanks working a certain simple way, having at least one drain plug where the water can be let out, and having a front end 111 rigging with a intake 110 area made for creating a skimming ability using added front end and internal tanks; Netting 405 which is made up of a mesh, wire, nylon, and or any other tough usable material where the porous weaving or construction allows water but not oil to pass through; Net Frames 401 which are made hold the Netting open and are used for skimming, trolling, and or trawling to collect and contain oil in a very simple way utilizing vessels available on site; Air Bubble Barriers which uses different types of pipes or structures to pump air bubbles from underneath the water surface so they either prevent oil from entering a certain area, to assist in skimming, aerate the water, and or to help separating the oil from water inside the barge skimmer tanks, etc.; Spotting using Drones and Blimps which are vessels than can be used but have not been used to date; etc. Another inventions is the addition of a Mobile Wildlife Cleaning Vessel 388 with a cleaning stations 15 (can be on any size vessel), which is a new invention for use in the water as a floating mobile animal, fish, bird, reptile, wildlife, etc. rescue vessel which can go about and rescue more creatures soiled with oil during and or after a oil spill (as a part of the response process). All the new inventions listed are new to a oil spill response process, and they can be easily rigged on site and deployed fast to help in any oil spill response situation. The new inventions can also be pre-made and ready for any spill. The barge skimmers are really good additions because they are stable in the ocean conditions, that have really shallow drafts where they have the capabilities of being used in as low as six feel of water, and they can collect super large quantities of oil. The barge skimmers can spin and or maneuver easily, and they can skim huge areas at once taking in huge amounts of oil; and while inside their huge tanks, they have the ability to use the natural make-up of oil and water as a simple separation technique; and they have huge decks making it possible to add more equipment and options to even make the skimming plus oil and water separation more efficient and effective.

To better explain the inventions in this response process, drawings with descriptions will be used. This process and or the descriptions and drawings just show the new vessels and new inventions, but they do not limit the new vessels and inventions as to maintaining a certain exact design, size, shape, etc. The drawings and descriptions will show and explain deployable application situations and techniques for where and how the listed inventions can be used, but they do not limit the inventions to just the listed uses or areas where they can be used. The term, ‘sensitive area,’ will refer to any area that is a environmentally sensitive area such as a marsh, swamp, fishery, breeding ground for a species, reef, etc.; and or any other area where the oil can do harm to wildlife, personal property, etc. This equipment may be used respond to many types of spills and in any body of water where it is practical.

Once the spill starts, the first step is to locate or ‘spot’ the spill. Spotting can be defined as simply looking for oil in the water; in deep ocean spills it is also looking for the place where the oil is surfacing and or coming up. Whereby just men on the ground or in boats used to be the primary technique for ‘spotting’ the oil, more technology can now be deployed that is better suited for doing this task. Spotting can be done using many different technologies commonly used in other areas for transit, recreation, communication, detection, etc. Upgrading and adding new types of vessels, equipment, and technologies for spotting oil is mandatory, and they should be added to the response process as they are developed or invented. Adding new spotting techniques should be a ongoing process in any oil spill process.

Drawing 1 Shows a Blimp 602 which can be used for spotting, following the oil, and for long term hovering during clean-up operations, etc. A manned or unmanned blimp is ideal in calm to breezy conditions, as it can hover very efficiently. A Drone Helicopter 601 and Drone Airplane and or Jet 603 are two more vessels that can be used for oil spill clean-up operations which have not previously been used. These vessels can provide a ‘eye in the sky’ as they can be outfitted with sensors, cameras, video equipment, etc.; all may be helpful. The Drones can handle many wind conditions, and they don't risk human life. The Drones can operate more efficiently than manned aircraft because they are often smaller. The Drones can also be released and recaptured out at sea whereas many manned vessels have to use landing strips on land. Also shown is Vessel 300 pulling a Net 405, with crab-trap style Net Frames 401. These nets and net frames can be trolled through the water and used to collect oil. When filled they can be hoisted on deck, and or suctioned out in the water, etc. Another option is for the Net bags to be removed, cinched where they don't leak, and a new net bag can be put on the net frames in their place. The filled net bags can be hoisted into a tank, burned, dragged to a dumping location, etc. Satellites 703 are also shown in the drawing. The satellites provide GPS tracking and spotting. The use of mapping software can help to mark locations where oil has been spotted so to send skimmers to the area; etc. Also, GPS can be used with software applications for guiding ships or vessels which can be manned or unmanned. The unmanned or manned blimps, drones, skimming or netting vessels, etc. can all use GPS.

Drawing 2 shows how the satellites 703 (A) and 703 (B) are working with barge skimming vessel 107 (A) and 107 (B); vessel 300 (A) and 300 (B) pulling a Net Skimming Frame' 401 (A) and ‘Netting’ 405 (A); and Vessel 300 (C) deploying Net Skimming Frame' 401 (D). To sum up Drawing 2, the Satellites simply provide GPS capability, and the vessels are simply using GPS to know where they are and where they are going; and they are going to the exact GPS coordinates determined in part by the Spotters and spotting technologies. Using GPS along with software, the skimmers and responders can better keep track of their directions and they can set their courses so that they coordinate with other vessels which may be miles away. Software solutions can be made in the future just for keeping track of large spills. Mapping systems and or mapping system software can be created to keep track of the spill, skimmers, etc. Of course ‘spotting’ and using a mapping system, in a spill situation, is a ongoing process that constantly needs to be updated to make sure that records are kept so that responders keep track of the locations where oil has already been picked up, and or where it is being picked up, etc. This is a process which is made easier by proper communication equipment such as cell phones, walkie-talkie radios, CB radios, etc. By ‘not’ spraying dispersant, all the oil should reach the surface where it can more easily be tracked and skimmed as it will be grouped into slicks. Due to the sticky peanut butter like texture of the crude oil in the Gulf of Mexico, the oil sticks to itself forming slicks, and those slicks can easily be seen from the air and tracked. However, if too long of a time goes by, sometimes the oil gets saturated and blends in more with the water, therefore efforts need to be made to just on and get to the oil as fast as possible.

The next section part of the process that will be described is the use of Netting along with the Net Frames. Net Frames 401 can be made from different materials such as: titanium, steel, aluminum, carbon, fiberglass, PVC, double carbon, etc. The Netting 405 (further discussed in Drawing 4) is made so that oil but not water will pass through. Drawing 3 shows a simple shallow draft shrimp boat 300 which has simply been converted to a Net Skimming system Boat. The Vessel 300 has a hoist system 402 which basically lowers the shrimp riggings or fishing nets, but in this case converted as having a Net Frame 401 A and B to either side; and instead of using shrimp or fishing nets, Oil Netting 405 A and B has been attached to both sides. The boat is in the water 102 and trolling for oil 101. In this case, the net frames do not have a rear, as they just hold the net and hold the net open. The rest of the netting is free flowing. Once oil nets get filled with oil, the oil is either suctioned out while the nets are in the frames, or the nets, are taken off, cinched, and then replaced by new nets; while the old nets are either pulled behind the vessel, hoisted onto the vessel, suctioned out, burned, taken somewhere and dumped, etc.

Drawing 4 shows the make-up or porous nature of the ‘weaving’ making up the Netting 405 material. The main difference between this type of net and a similar net that you might get bugs out of a swimming pool with, is that this net would have to be made strong enough and big enough for use in trawling and or trolling for oil collection, and the weaving has to be small enough to trap the oil but large enough to let the water pass through. The netting has to be strong enough to hold the amount of oil than the net can hold. The purpose of the net is to collect the Oil 101 while letting the Water 102 pass through but not the oil, as shown in Drawing 4. The Netting can be made from materials such as: cloth or fabric; wire ‘screens’ (such as used in window and or screen doors); a mesh-like material similar to what some lawn chairs and or lawn furniture is made from; nylon; any material rope is made from; and or any other type of fabric or material put together or woven in a similar porous pattern, as shown in Drawing 4. The choice of Netting materials may even differ depending on the viscosity of the crude oil or contaminant, but the overall concept remains the same.

One method of using the Nets 405 is to assemble Net Frames 401 and then convert fishing, crab, or shrimp vessels, etc. (like drawing 3) so that they can be used in the skimming process. By doing this it keeps the fishermen, shrimp fishermen, etc. employed whereas they would likely be out of business in the area where the spill happened. Drawing 5 shows how the Netting 405 can be made into a trash bag or sock-like Netting bags, and then attached to, in this case, a Net Frames 401 similar to a crab trap. Drawing 5 shows a ‘crab-trap’ like Net Frame 401 being held in place by the Hoists 402 (normally or likely used for trolling shrimp nets and or trawling fishing nets) on the boat or vessel 300, which resembles (in this drawing) a shrimp boat. The Hoists or Boom Equipment 402 extends outward to both sides of the vessel 300 so that they hold the Nets 405 and Net Frames 401 in place where part of the net frame is just above the water 102, and the rest of the trap extends below the water surface as they trawl the waters. To keep the Net Frame at the right height just at or slightly above the water surface, floater and or small buoys can be used and affixed to the Net Frames 401, and or and Hoist Booms 402 can be set in place also. Netting 405 can be made in many sizes and shapes, and the Net Frames 401 can also be made in many sizes or shapes. Drawing 5, also shows how the Netting 405 (A) and 405 (B) has already been filled with oil, taken off the Net Frames 401, a new Net 405 bag put on the Net Frames, and the old Netting 405 (A) and 405(B) has been cinched with a drawstring and or cinched by any possible method, then towed behind vessel 300 until they can get to a place where the filled Net bags can be disposed, suctioned, dumped, burned, etc.

Drawing 6 shows one version of a Net Bag 405 before it is put on the Net Frame. These bags do not have to look ‘exactly’ like this, nor be this size, but this is a example. The Net bag 405 in this drawing has some loops 409 at the top where it can quickly be attached or affixed to a Net Frame. Of course all Net bags would be made specifically for the size net frame they are to be attached to. This Drawing shows the opening area 405 (B) for the Net 405 bag, and the oil would of course enter in the bag through the opening. This Net bag also has a drawstring 421 where it can easily and quickly be grabbed and tied or cinched shut. The Net bags 405 in this drawing work very similar to putting a trash bag on a trash can, and then when the net bag fills with oil, it is taken off the net frame just like a trash bag, cinched, and then disposed of.

Drawing 7 shows one version of a trolling Net Frame 401. This is similar to the Net Frame in Drawing 5, but this type of Net Frame 401 is open in the front (as the others) but also the rear; thus allowing the attached Net Bag 405 (A) to extend rearward beyond the confinement of the Net Frame and flow freely. This Net Frame 401 is a rigid structure where the netting can be attached so that the Net Frame can be trolled and or trawled through the water with the ability to hold its entrance or Net opening 405 (B) shape. The Net Frames are used to creating a mouth-like opening so that when trawling/trolling the surface of the water for oil, and or under the water surface for oil/dispersant mixes, the work is made easier. Because the Netting, in some cases resembling socks or bags, can be made to attach to the Net Frames using little common hooks 409 on the frames, or rope ties, etc.; when the nets get full of oil they can be easily taken off the Net Frames (similar to a trash bag) and the drawstring 421 can be used to tie or cinch the Net shut to keep the oil from escaping. After a old Net is taken off, a new Net can quickly replace it so that they can continue the operation. The full nets would then be towed behind the boats, or hoisted onto vessels, taken to a suction or disposal vessel (if the vessel does not have equipment on board to handle to suction and contain the oil), burned, etc. Of course once the nets become full, suction equipment can be fixed onto the frame in some way so that it can just be momentarily turned on to suck the oil out, etc. Many options are available in this area.

Drawing 8 shows the Net Frame 401 that resembles a ‘crab trap,’ or ‘lobster trap’ which is basically a cage. You just put the. Net bag 405 in the Net Frame 401 and affix the Net Bag via loops 409; then you affix the Net Frame 401 to the end of a trolling boom or hoist 402; and then it is trolled through the water with part of the Net Frame just above the water line, with the open end facing the direction you are going. This is done so that the oil can enter the open end and be captured in the nets. The Net Frame 401 in Drawing 8 will maintain buoyancy via floaters 404 on the frame. The floaters 404 (foam or any other floating material capable) will keep the Net Frame at the right trolling height or depth so that the Net Frame collects the oil floating on top of the water surface. When the Net bag gets full, you just pull the drawstring and or detach the Net from the Net Frame; and then you replace the bag and keep going. The Net bag will then be hoisted onto the deck of the ship, towed behind the ship, and or the Netting can be suctioned out instead of taken off. The net bags can also be burned, taken to a dumping location, etc. The net disposal locations and methods can be determined depending on the spill size, spill location, as well as the number and capability of the vessels in the response, etc.

Of course the Net Frames can be made in any size. The Net Frames can be made from many different materials, and the material make-up for the Net Frame would be likely be determined based upon the eventual or desired use. For the Net Frame in Drawing 8, which resembles a crab trap, the Net Frame has the option of being made by several different types of rigid materials strong enough for handling the job. Of course the materials that make up all the designs, shapes, and sizes of net frames would have to be strong enough to handle the job. Some materials that can make up the net frames are: titanium, aluminum, PVC, steel, wood, graphite, fiberglass, carbon, Plexiglas, carbon carbon, etc. In Drawing 8, the steel or aluminum tubing frame is made up of roughly six foot long and six foot deep aluminum tubes attached by, for example; by joint attachment 411 (A) piece. The joint attachments 411 (A) piece could be threaded, wielded, glued, with screws, etc. The same type of device could easily be made from steel or even PVC.

Drawing 9 shows one example of the many ways for how the Nets 405 and or net bags can be used in a response process. Drawing 9 shows vessel 300 (A) using the hoist 402 to lift a Net 405 bag out of the water and perhaps into a dumping container on the rear of the ship; and or the hoist 402 can be lifting the Net 405 bag out of the water so that a suction hose can be inserted into the bag and the bag cleaned out. Drawing 9 also shows vessel 300 (B) pulling four cinched and filled with oil Net 405 bags to a dumping vessel 300 (A).

Drawing 10 shows vessel 300 (A) and vessel 300 (B) pulling a super large net 405 and net frame 401 through the water 102. Ahead of each vessel are booms 777 (A) and 777 (B) which act to funnel the incoming oil into the larger oversized net 405. Booms 777 A and B help the oil collection by making each swipe up and back through the water to take in or engulf a larger amount of oil with every swipe. The Net 405 is shown in this picture to be trolling on top of the water. However, if there was a column of oil/dispersant mix hovering at a certain depth below the water surface, a similar Net 405 would simply be used and extended downward via ropes or poles, etc. and using the current to assist along with a trawling technique, the net can engulf the oil/dispersant mixed. Both processes are similar, the depth of the net in the water being the main difference. The mouth of the net is held open both by the speed of trawling (if there is no super rigid frame), and or by the structure and make-up of the Net Frame 401 (very commonly done for fishing). Divers, submerged vessels, and or submarines, etc. having underwater cameras, etc. may be used to better target the clumps so that the nets are more effective.

Skimming Barges 107 are next piece or part of this process. This best part about using the equipment in this whole process in general, is that this does not have to be a passive process. The equipment, such as the Skimming Barge(s) 107, can be very aggressive response equipment, depending on the user, as it creates the ability to go and get the oil; as opposed to just sitting out equipment and hoping it works. Drawing 11 shows a new ‘Skimming Barge’ 107. The flat bottoms and low draft of the Skimming ‘Barges’ allow for the barge to be used in shallow waters, reef areas, and or at least closer to or in more environmentally sensitive areas than the larger deep hulled deep draft traditional skimming vessels. Some super large Barge Skimmers 107 can be made so large that they can hold more than 200 thousand gallons of oil in their internal tanks/containers/pools. Not only can large barge skimmers perform in shallow waters, but the much wider, heavier, and longer barges are big enough to be stable and usable in rough seas most skimming vessels are not able to handle. Other equipment, such as Hoists or Lifts 402, Vacuums 104, Generators 106, and Oil Centrifuge 105 equipment, etc. can be added to and or affixed to the decks of the barges. Also, there are many different methods, ways, and designs for coordinating and constructing a proper piping, plumbing, and or hoses on the decks, in the tanks, from the intake, from piece of equipment to the other piece of equipment, from drains, pumps, etc. so that the equipment can be used together to further separate the oil from the water after the oil is initially collected (or taken in) so that the oil is contained while the water is pumped back into the sea. By adding the equipment, and then having equipment such as the Vacuums or Pumps 104 and the Oil Centrifuges 105 working together, it creates more efficiency and overall effectiveness in the clean-up operation. The additional water cleaning processes made possible by the added equipment allows for a higher concentration of oil per water amount to be contained in the barge skimmer internal tanks. Therefore it prevents wasting internal collection tank area by filling it too heavily with water. This also allows the Barge Skimmer 107 to get the most effective and efficient use of its internal containers every time or day it is being used. A front end is rigged to a barge with a opening or intake area 110 that allows the oil to be funneled inside. The oil gets funneled into the intake area and into bulkhead where one or more of the spill over pipes, vacuum/suction, weir pump suction, floaters, skimmers, vacuum hoses, etc. (depends on front end and intake area design) are located. For example, the oil would gets funneled into the intake area as a tugboat or towboat pushes the barge skimmer through the water. As the oil gets funneled into the intake into a bulkhead, with one design the oil falls over and into a pipe where it then gets suctioned into a rear collection tank. Once inside the collection tank, the water can either be further separated by pumping or moving the water from tank to tank, etc. In the tank the water goes to the bottom while the oil goes to the top. The water can simply be let out via drain connected to a hose or pipe which extends or is at the bottom of the tank so that just the water is let back out while the tanks fill with just oil. Of course the weight of the water and oil to force out the water out when the drain is opened at the bottom. The water gets forced out with a good enough force so to kick out any type of fish or turtle etc. which may have been sucked in or fell over inside the tank. This skimming system, and the way the tanks work help to create better efficiency in the clean-up process. The following drawings will show some of the many possible designs, as well as it will repeat the internal workings.

That being said, Drawing 11 shows the newly invented ‘basic’ version of the ‘Barge Skimmer’ 107, without much ‘extra’ water cleaning equipment added. The Barge Skimmer 107 has a protruding front end 111, but it can be intruding also. The front end is actually a part that can be rigged on site and added to the barge so that it offers a area containing a degree of skimming, but also having internal equipment added such as: pumps, vacuum equipment, floaters, raised pipes, etc. so to just take whatever is floating above the water surface. The front end and intake area 110 is also the first part of the oil and water separation process. The lower part of the intake area 110 of the front end, in Drawing 11, has been designed for sliding under the water line with a extension that slides just under the oil, allowing only the oil to collect or be funneled into a bulkhead where the oil spills over into a pipe then gets suctioned into a rear tank. Also, the front end can be made many different ways so to have other types of devices added so to help collect or suction only the oil from the intake area to the rear tanks while not allowing much water to enter. These types of front ends and intakes have been added to deep hulled super skimmers in the past, but they have not been added to this type of barge with this type of internal workings (also used this way with this type of added equipment). In Drawing 11, the oil is collected and or spills over into the piping system and or internal tanks. Extension arms and or Booms 777, shown in Drawing 12, can be added to the front of the barge skimmers so that they can extend outward and further apart from both sides of the front end opening of the barge skimmer 107, and in a forward direction away from the front end 111 of the Barge Intake area 110. Drawing 12 gives a real good example of how the vessel or towboat 300 (A) and vessel 300 (B) can pull a Barge Skimmer 107 through the water using Booms 777 (A) and Boom 777(B) to their advantage by using them to both pull the Barge skimmer and create a ‘funnel’ like ‘V’ shape to collect more oil into the Barge Skimmer Intake 110 area.

Drawing 11 shows the basic Barge Skimmer 107 set up. This Barge Skimmer 107 in Drawing 11 only has one big internal tank 120 (after the intake) for which to collect and contain the oil. Once the oil enters through the spill-over ‘Intake’ 110 pipes, the incoming Oil 101 then will float on the surface or top of the water inside the main tank 120 while the heavier water 102 goes to the bottom. In other more advanced Barge Skimming designs, there might be several internal tanks, and each tank having the option of adding vacuums, pipes, and or centrifuge equipment so that the tanks can be used for a type of internal water and oil cleaning process. Inside the barge internal tank 120 in Drawing 11 showing Barge Skimmer 107, the oil 101 will float to the top while the water 102 goes to the bottom. After the internal barge tank begins to fill up, a crew member can then simply open the plug 151, which is a drain plug for this particular barge Skimmer, which is connected to the Hose or pipe 150 and extending down to the bottom of the barge container 120; and used for simply letting the clean water from the bottom of the container drain or spill out until oil is spotted in the water coming out. Once the water coming out of the plug turns to oil, then you replace the plug and continue to skim. Also, the drains can be opened and closed, then the internal layers measured to see if the drains need to be re-opened (in other words, you don't have to always wait until oil comes out before you re-plug the drain). Once the Barge Skimmer gets filled with oil, then it can then be taken to a tanker nearby, where a suction hose or several hoses can be inserted into the barge tanks and the oil sucked out.

With the proper number or fleet of barge skimmers built and used for skimming, there is no reason why a 50,000 barrel per day spill could not be easily be entirely cleaned up. The key to cleaning a large spill, is to get on the clean-up as fast as possible while having the proper vessels and equipment plus number vessels available; and efficient use of the skimming time is also a major factor. The maximum ability for the barges, in terms of oil skimmed per. day, can be calculated. If the spill volume exceeds the maximum clean-up potential for the skimmers, then there is no way to handle the spill without using multiple additional measures.

Drawing 12, also gives a example of the Barge Skimmer with several pieces of equipment added to the deck to make the clean-up process more effective and efficient. The Booms 777 (A) and 777 (B) do a lot to increase overall effectiveness, in terms of covering a much wider skimming surface area with ever pass back and forth through the water. However, when adding the extra equipment, such as the Vacuum Units 104, piping or hoses 150, Oil Centrifuges 105, and Electric Generators 106, Hoists 402, etc. and then use them in conjunction with multiple internal tanks 120 (a), 120 (B), and 120 (C), and integrating the internal piping or plumbing system where the equipment can work individually but also be connected so to work together as a team; then the Barge Skimmers and clean-up becomes more efficient. By using the added equipment to further clean the oil from the water while entering and or once in the barge containers, then a higher percentage or concentrations of just oil will be contained in the internal tanks; while returning the cleaner or cleaned water (cleaner); and while the oil collected might now be usable for some purpose. If the oil collected is usable, then it is sellable. By selling the oil collected, the cost of the clean-up can be somewhat offset; and incentive for clean-up crews to work harder would also be in place if they some kind of profit revenue from the sold oil. Of course, all the barge skimmers, suction vessels, etc. can empty all the oil or have the oil suctioned into tankers which can take the oil to a external or land based location where the oil can also be further cleaned for the same purpose.

In Drawing 12, the oil would first go into a ‘collection tank area’, or Intake 110 area, and then the vacuums 104 would then suck the oil/water/etc. mix into the larger tanks 120 (A); and or suck the oil straight into a Oil Centrifuge 105 equipment for cleaning where a higher concentration of oil will be then scraped or suctioned into container tanks 120 (A) while some of the water can already be pumped out at this point. If the oil gets sucked into tank 120 (A) first; then the oil might get sucked from tank 120 (A) and into one or more of the Oil Centrifuges 105, where oil and water would be spun then the oil scraped and or suctioned into the collection tank 120 (B) or 120 (C), and then the clean water would be pumped over board, recycled, and or reused, etc. Clean water may also be pumped in from deeper water and or containers (not in the drawings) holding fresh or clean water, just to help operate the Centrifuge equipment while at sea. Chemicals and or more salt can be added to the water in any of the internal tanks, and or in the Oil Centrifuge equipment, to help make the water and oil separate better as well. Multiple tanks can be used in the same or one single Barge Skimmer to create a whole self contained water cleaning process. However, and also, the option exists during larger spills that several barges can be tied together, each containing similar vacuum and or centrifuge equipment, etc. with each barge becoming one part of a multiple barge cleaning station. In this case, all the barges would work together become a large multi-vessel mobile water cleaning station where the other Barge Skimmers, other boom skimmers; suction vessels, netting vessels, etc. can all take their collected oil and offload it for cleaning. This would also provide a docking port, at or in the middle of the sea, where a tanker could pull up next to, and extract the collected oil.

Drawing 13 shows a multi-Barge Cleaning Station and or Station 200 consisting of Barges 107 (A), (B), and (C) tied together. The Station 200 can consist of any number of barges, specialty platforms, vessels, etc. Station 200 is just drawn in this drawing as having three barges tied together for the purpose of being a station to cleaning oil from water, as well as be a docking location at sea. The Station 200 can be used many more ways. The Station 200 is not mandatory for all spills, however for large spills it can provide a possible ‘at sea’ docking point for offloading oil collected by the skimmers (including barge skimmers), etc. If the Station 200 is to be used as a cleaning station, the water and or oil refinement process can begin by using many options of equipment such as: oil centrifuges, air bubble techs 132 (described later), conveyor belts, aeration techniques, steam, etc. and or any type of water cleaning techniques known to the industry. In all the internal collection tanks for barges or cleaning stations, types of dispersant (known or unknown) can be added. In all the collection tanks inside barge skimmers or at barge cleaning stations, etc. ingredients can be sprayed onto the oil water mix, so to cling to the oil making the oil sink to the bottom while the water comes to the top (which is a reverse of the previously described internal water cleaning or oil containing techniques). Drawing 13, also shows a Super Tanker 308 (A) using hose 150 to suction oil from the last barge 107 (C) of the Station 200. The Station 200 can also simply be a place where all skimmers can go to offload of have their oil suctioned out, etc. Station 200 can also be a place to refuel, eat, drink, have a floating first-aid or medical station, etc. In other words, it can serve more purposes and does not necessarily ‘have’ to be a place where any real cleaning of the oil and or water is done. It also provides a location where on scene coordinators can get together and plan the next round of skimming, it can be helicopter pad, etc. The Station 200 can also have sleeping quarters or rooms, beds, etc. to house response workers who are working shifts, etc. The Station 200 can provide a ‘at sea’ possible location for virtually any reason. Having a location such as this, for cleaning the oil from the water, would depend on the desire of the clean-up or spill coordinator, and or if the oil could be used or sold; and or if certain government regulations require it; etc. Drawing 13 also shows Barge Skimmer 107 (D) being pushed by Towboat 300 (B) to the Barge Cleaning Station for off-loading.

Drawing 14 shows several possibilities for different size Barge Skimmers 107. Drawing 14 shows a super-sized Barge Skimmer 107 (A); a large Barge Skimmer (B); a water or hydro-jet propulsion 109 (A) driven M-hull design Barge Skimmer 107 (C); a smaller 1/2, 1/3, or 1/4, etc. sized Little-Barge Skimmer 107 (D) which also showing the possible option of being a propeller 109 (B) unit; and lastly a micro-Barge Skimmer 107 (E) with a propeller driven unit 109 (C). Any Barge Skimmer can be fitted with a motor and a propulsion system, although barges having propulsion units are not often used in the USA. Any of the Barge Skimmers can have their own propulsion units, or they can be pulled and or pushed by tug or towboats, etc. The larger Barger Skimmers may be both pulled and pushed by tug or towboats in order to use the booms or any other equipment attached to the fronts ends 111 and extending outward and wide so to engulf and or funnel much more oil into the Intake area 110, thus taking in oil from a much wider surface skimming area. The smaller Barge Skimmers, like 107 (D) and (E), can be pulled by smaller vessels or boats and use the booms, etc. to funnel oil into the mouth or Intake area 110, in much the same (even exact) way as the larger barge skimmers; but they can also have some type of propulsion system added to them as well. This drawing 14 is just to show that from the largest of barges to the smallest barges (perhaps even 1/10 scale or smaller), the overall concept remains the same. All sizes can have a intake area 110, a front end 111 where any type or form of extension arm, booms, etc. (there are many possible designs and ways already known for other vessels) can extend outward and wide to be used to funnel in and engulf a much larger surface area, etc. The front end 111 designs can increase and or make more precise, the oil intake ability, and then when the oily water gets inside the contained area, the water at the bottom can be let out (or pumped out) while (hopefully) only the oil fills the tanks. All the barge skimmers have the option of using added equipment such as, but not limited to: vacuum pump 104, generator 106, and or centrifuge equipment 105, Containers (not numbers), depth gauge, GPS navigation equipment, etc. Anything that could be added to further enhance their overall abilities, can be added.

Drawing 15 shows a Barge Skimmer 107 having several pieces of equipment added. It shows the Generators 106, Oil Centrifuges 105, Vacuum Units 104, as well as a open rear tank 120, which can be covered or uncovered. The rear tank 120 opening is meant to show how the tanks can be uncovered or covered; and when uncovered in one area (such as in the drawings) it gives access to the holding chambers or tank area; so that the layers of oil/water can be checked using the Oil/Water Checking Tube 802 (see Drawing 16 for a descriptions of this part). The smaller opening for the rear tank allows for responders to more easily determine how much oil is in the container, as well as how much water needs to be pumped back to sea etc. The piping system and or hose system 150 at the protruding front or entrance 111 addition to the barge skimmer 107, shows that the vacuum suction units 104 can be used to suction the oil from the top of the water as it enters the intake area 110; and it shows hoses 150 that can suck the oil and water mixed from the first internal tanks, where the intake tank is located, to the rear tanks; or into the centrifuge equipment before it goes into any holding tanks. Some of the possible suction locations are shown at points 151 in the front of the barge, but in no way does this drawing, or any of the drawings or descriptions, limit the Barge Skimmer to having one particular design of any one specific area, location, method, etc. for housing or positioning any of the piping, vacuum, centrifuge equipment, etc.; nor does it limit the barge skimmer to have to have any amount or number or hoses or pipes, number of vacuum or centrifuge equipment, etc.; nor does it limit the Barge Skimmer to any number or shape of internal or external chambers, etc. The rear points, also number 151, can be optional areas where the oil can be pumped out, vacuumed out, and or where the internal tanks can be sucked out by other suction hoses, etc. The hoses 150 going from the front of the intake area 110 to the rear equipment area (where 104, 105, and 106 are located) can suck the oily water straight into the centrifuge equipment 105 so that the oil can be separated while the water is pumped out of one of the rear 151 locations into the sea. The suction equipment and the centrifuge equipment can work together in various ways to make the oil containing, and or internal cleaning, and or storage processes, etc. more efficient. This drawing 15 just shows one more design of a barge skimming vessel 107 with optional design extras and optional equipment added. By adding the extra equipment and options, it creates the ability to tailor the efficiency of the oil collection and containment, which may be necessary for large spills. This drawing does not limit the Barge Skimmers to having to have this exact design or equipment added.

Drawing 16 shows a Oil/Water Density Checking Tube 802 (Checking Tube for the remainder of this application). The ‘Checking Tube’ 802 is a measuring device which measures the layers of oil, oil water mixed, and water inside the Barge Skimmers and skimming vessel containment areas or tanks. A example of how the Checking Tube 802 works is as follows: it is just like sticking a straw into a glass of water or any other beverage with one end uncovered; you put your finger over the uncovered end that sticks out of the glass to close off the air, thus trapping the air and liquid inside the straw; and then you can pull the straw out and see the liquid in the straw while the liquid stays in the straw; and then when you are done, you take your finger off the end and then the liquid or water falls out. The overall utility of the Checking Tube 802 is designed for measuring the layers of the oil, oil water mixed, and water that is inside the tanks of the skimming vessels; and it should work just like the previous example. The Checking Tube 802 is of course a tube shaped rigid piece made of clear plastic, glass, Plexiglas, and or any other material that can be made clear and tube shaped that will work as intended. The Checking Tube 802 ideally can have a diameter of anywhere between one inch to eight inches, a length longer than the depth of the skimming vessel tanks it is checking (which means that they can vary in length and overall diameter). The Checking Tube should also have a ruler like markings on it so to use as or with a metric or American measuring system. One end of the Checking Tube should be capped, but with a small ⅛ inch to ½ inch or so in diameter hose 150 (there can be many different diameter hoses and many lengths that would work) attached through a hole in the cap, it should be airtight, and extending from the capped end with the other end of the small hose connected to a small hand held Pump 803 along with a Valve 804 connected to the pump and hose system. The diameter for the hose 150, the length of the hose, and the overall diameter and length of the Checking Tube can vary somewhat, but the general look of Drawing 16 should give a pretty good idea of what the product should look and resemble. There are different ways to make the valve and cap system work, and the pump is a option that can be taken off. The Checking Tube 802 is stuck vertically down into a holding tank, with the Valve 804 in the open position. Once the tube opening end 801 is put down in the tank touching the bottom with the submerged end 801, and the whole Checking Tube held vertically in place with the other end sticking straight up extending out of the tank, (the Pump 803 may or may not be needed), the valve 804 is then shut. When the Valve 804 is shut, it closes off the air on one side of the tube, thus trapping the oil and water inside the tube. When the tube is taken out of the tank, you will be able to see through the clear tube and measure the layers of oil, oil water mixed, and water inside the tube; thus being able to determine the situation inside the tank. Again, this device measures how much oil 101 is on top of the water 102, how much oil and water is mixed 250, and how much water is at the bottom of the tank that needs to be let out. This will give the operator a better idea of what the vessel and or Barge Skimmer collection tanks are holding, and it will give them an idea of how much water needs to be cleaned by the Oil Centrifuges; or whether the vacuums need to be used; if its time to go to off-load; etc. By having this gauge or Checking Tube to quickly measure of how much water needs to be let out, how much oil/water mix needs to be cleaned, how much oil only is being held, etc., it can help determine many different things. The clean-up process can be actually be very precisely measured and calculated just by having this Checking Tube. The Checking Tube can help to make the use of the Barge Skimmers more efficient and effective. This Checking Tube can also help in the refinement or cleaning process, and it can help with other skimmer systems as well. The use of the Checking Tube will help determine at what depths inside the collection tanks to suction water for internal tank cleaning, etc. There are a bunch of advantages to using the Checking Tube. There can be different designs for the hose and pump part of the Checking Tubes, but in designs there must be a valve that shuts the air off to a top cap.

Drawing 17 shows a Conveyor Belt 510 type of device or attachment which can be easily added to the front of one of the Barge Skimming 107 vessels to assist in the oil intake. This conveyor belt system 510, will use a belt that may or may not be made from rubber. This is shown to be rubber with cups and or raised ridges to help scoop or collect the oil as the worker 608 uses a squeegee 407 to help push or pull the oil 101 onto the belt. The belt can be at varying lengths and or adjustable inclines, so the incline of the belt should be adjusted for the type of contaminant, oil thickness, and the situation. The incline of the belt is useful for the oil clean up, as well as for the water separation process. As the oil is pushed or funneled onto the belt, the crude oil will likely stick to both itself and to the belt as the belt is turning; but most of the more heavier water should fall down not collecting. Therefore, as the oil rises with the belt, the water can begin to fall or separate at this point. Further separation may be needed once the oil is inside the containers 120. Little cupped, raised, or formed parts on the belt (not numbered) helps in grabbing clumps of oil as the oil makes contact with the belt. The belts can be any width usable and made from any material usable and effective. Parts may be added so that dispersants, steam, or other cleaners might be sprayed onto the belts so to help knock all the oil off the belt as the belt makes the loop in the conveyor process. This process may use either pumps, piping, nets, shovels, squeegees, spraying equipment 161 with pressure hoses attached 162, etc. to clean, brush, spray, and or scrape the belts during operation. Additionally, Conveyor Belts 510 may also be used in manipulating the oily sludge or disposed in the oil Net bags 405 as they move throughout the process from vessel to barge, from barge to barge, and or during a cleaning Station 200 operation, etc. Basically, this drawing just shows the scenario where a conveyor belt system is being used to help collect oil into a barge skimmer during a clean-up operation. This drawing does not limit the conveyor belt system to only this use or position in a clean-up operation, nor does it limit the Conveyor belt to having a particular shape, size, incline, look, use, or form, etc.

Drawing 18 shows Barge Skimmer 107 that works a little different on the inside than the others. This is just a option for oil containment and or water oil separation after the oil is collected and stored inside the barge. Once the oil 101 enters the Intake area 110, dispersant 262 (or any other type of product or ‘bio’ material usable for this) is sprayed from a Sprayer 261 located on the barge deck and rigged to spray into the internal tank. This type of material or spray 262 would making the oil dispersant or spray ingredient mix 260 attach to the oil making the oil mix heavier than water so that the oil/dispersant/ingredient/etc. mix goes to the bottom of the internal barge tank area while the lighter, water 102 would rise to the top. Inside the tank, the water 102 would rise to the top and the barge dispersant 260 etc. mix goes to the bottom so that the water could be pumped out making the containment more efficient. This is something that is possible after the oil is collected to make the holding of the oil, and or the separation of the oil and water better, easier, or more efficient (this is just a option). Also, this might be something that is done after all the other tank have been suctioned into a larger tank where the oil is to be refined, or cleaned, or burned, or disposed of, etc, This is to show only a potential process option and not a requirement for this process.

Drawing 19 shows a Barge. Skimmer 107, which works internally in the same or similar way as the others (except for drawing 18 . . . so there is not any reason to repeat that part), but this skimmer is fitted with other equipment such as: Hoists and or Booms that act as cranes 402, a big Wedge Shaped Front End 112 with a Cable Lift 914, and ability for the outward end of the lift to raise up while the other end remains in place so that everything on the ‘wedge’ gets dumped into the barge Intake 110 chamber. This would be considered more of a hoist or dumping Barge Skimmer even though it is still represented by the number 107 in the drawings. Additionally, the on the actual wedge 112 in this drawing, there are a bunch of small Holes 132. These holes can be drilled and small enough to allow the water to pass through and not the oil, or they can be a place where air is pumped into the Wedge 112 front end so that air bubbles escape through the holes making the oil rise to the surface of the water for suction equipment to simply lift it the rest of the way off and into the barge; and or for ease of skimming; and or for ease of dumping; etc. The air bubble technology will be further discussed later in this application. The hoists and lifts on the sides of the barge can also act to pick up the filled oil net bags 405 and help to lift them into the collection tank of the barge.

Drawing 20 shows a additional very simple front end 111 for a Barge Skimmer 107 which when pushed or pulled through the water by a tugboat/towboat and or pulled by vessels, the front end is shaped so that oil is funneled is into the intake area 110 and into a bulkhead 158 where the oil spills over into a Hole 158. One through the hole the oil can then spill over into one or more pipe opening which can direct the oil to a vacuum and or into a collection tank. The oily water can also be suctioned from the intake area and into a rear tank. A vacuum/pump system 104 and suction hose 150 is on the barge deck. The vacuum/pump units can be used in several areas. The vacuums can suck the oily water from the intake and or from the collection areas and pump them into the rear tanks 120 (A) and (B); and or the vacuums/ pumps can also assist in moving the oil from tank 120 (A) to tank 120 (B). The rear deck area shows two uncovered pools or container areas 120. Tank 120 (A) is the first tank where this particular design shows the oil goes. In this tank the oily water 250, oil 101, and water 102 is all mixed. The oil is drained through hoses/pipes from tank 120 (A) to tank 120 (B). Once in 120 (B) the oil 101 rises to the top of the tank, while the water 102 goes/sinks to the bottom. A simple drain on the side of the Barge Skimmer 107 can be opened to let the water out of the bottom of the tank while the oil fills the tank. To drain the water from the bottom of the tank, a simple solution exists. A drain connected to and or at one end of a pipe or hose on the side of the deck or barge skimmer extends down to the bottom the tank either from internal or external plumbing of the pipe or hose, with the other end of the pipe down at the bottom of Tank 120 (B). Because the water is at the bottom of the tank and separated from the oil on top, when the drain is opened the water drains out of the bottom first while the oil stays on top. This is a very simple method. By this simple concept, efficiency is added to skimming operations. Also, to make this better, other equipment has been discussed as being added to further clean the water while in the tanks so that even a higher concentration of oil can be kept inside the tanks while a cleaner water can be pumped or drained out. This is just one on many possible designs for the intake of the oil. Of course when suction equipment is added, the front end intake areas can use suction vacuums just above the water surface so that they suck the oil ‘up’ and into the tanks. Other types of similar fronts ends can be used also. This or any front end design, in this application, does not limit the Barge Skimmers to having to have one specific front end working or design for the entrance of the barge. Steel or wire strainers, small holes in the bottom of the pipes etc., similar to the workings of the netting, can be used so that when the oil is moving through the pipes the water but not oil is falling out, etc.

Drawing 21 shows a Barge Skimmer 107 with another option for a front end 111 rigging. The intake area 110 is built to funnel the oily water into a bulkhead area where a vacuum system 104 on top of the barge deck has a hose 150 (A) or pipe extending downward and into rear the intake area at the bulkhead. The hose can be set at different heights above the water line. The hose has a opening 151 which suctions the oil from the top of the water and then pumps it into a collection tank 120 in the rear. Of course any of the collection tanks can be covered or uncovered, depending on the barge converted or the desired design. Also, there can be a plurality or multitude of separate hoses or pipe structures inside the intake area and suctioning the oil from the water. The pipes can be designed with screens covering them so as not to allow large sticks or sea weed etc. into the tanks. Also, weir vacuum pumps or any other known system for suctioning oil and secured inside the intake area.

Drawing 22 shows a type of barrier system new to oil collection called a Air Bubble Barrier. To make a Air Bubble Barrier 132, holes are drilled into pipes, tubes, and or hoses, etc. (see drawing 22). The holes are drilled on one side of the pipes (using pipes as a example) lengthwise, the end of the pipes are capped, and then a hose from a air compressor 271 or aeration device is then pumped through hoses 150 into one or both ends of the pipes. Drawing 22 shows a generator 106 providing power to the air compressor 271. The Air Bubble structure 132 is held in place by anchors or concrete blocks 714 (A) and 714 (B). A string shown in drawing 20 on 714 (B) so to help and bring the anchor or block to the surface and or to help lower it (a similar string would be on the other concrete block or anchor also). The lowering into the river, lake, or ocean is done by strings 255 A and. B. Strings 255 A and B can also help to set the whole system in place in the correct upright position. Once in the correct position, either on the floor of the body of water or somewhere below the water surface (as they can be hanging or setting on a structure, etc. also) air is then pumped in from one or both ends. When the air is pumped in it causes air to escape through the holes. As the air escapes, air bubbles are formed. When the air bubbles are released from the bottom or below the water surface, the air bubbles rise to the top. When the air bubbles rise to the top of the water, it should create a upward current from the release point of the air bubbles to the surface. Therefore, a up-current creates a wall which is very difficult for the oil to pass through. Releasing air bubbles in a already oil saturated environment also puts much needed oxygen into the water so to help the fish breathe (because oil depletes oxygen levels).

Drawing 23 shows the Air Bubble Piping 132 protecting the Bay entrance between 130 (A) and (B) while it is held in place on the ocean floor 30 by the concrete blocks 714 (A) and (B) on both ends. Both a Generator 106 is powering a air compressor (not seen in drawing), along with a Windmill 113, and they are attached to a hose 150 through which the air is being pumped into the piping forming a air bubble wall 133. In areas where the oil slick actually or gets passed the water surface having the air bubble barrier entrance, the air bubbles can still keep the oil at the surface for easier skimming.

Drawing 24 shows a Barge Wall 180 having a Air Bubble Wall 133 under it lengthwise and alongside it. The Air Bubble wall acts to both slow the oil slick down as it approaches, and it also helps to keep the oil and any other debris pushed to the surface so that the skimmers and suction equipment can better perform their tasks. Drawing 24 shows a bunch of different kinds of Air Bubble Piping 132 styles and designs. The equipment for providing air through the hoses 150 and into Air Bubble Piping 132, is located on top of the barge wall; and the equipment is basically generators 106 attached to air compressors 271 or vacuum/compressors 104/271, and or windmills 113. Any piece of equipment that can create and or pump air, that is also usable in the conditions, can be used.

Drawing 25 shows a response vessel called a Mobile Wildlife Cleaning Vessel 388, which can be a fan or swamp boat, or any smaller boat. This particular vessel is shown having a roof for shade, and a propeller style propulsion system. The drawing shows the worker 608 using a small wet/dry vacuum 404 (A) with a extended hose attachment 118 to suck oil from the water. A extra container 10 (B) is on the back of the vessel which holds either clean water for the cleaning station 15 or it can be a container so that more oil can be collected. Also shown in drawing 25 is a mobile bird, reptile, fish, animal, etc. cleaning station on the vessel, and represented by number 15 (further described in Drawing 26). In drawing 25, a micro cleaning station 15 is shown as a small extra part on the mobile smaller suction vessels, but there are other vessels that can be made solely for mobile cleaning station purposes; which is also a part of this clean-up process. The cleaning station 15 might consist of a few tanks or sinks where a bird can be soaked with Dawn brand or another brand liquid soap, soaked or dipped in different tanks each having different degrees of clean water for rinsing, and then places where the animals, etc. may be caged until they get to a place where they can be let go or further cleaned. The long hand held Scoop Pole 481 containing a wildlife Scoop Net 485 helps the response worker 608 pick up birds, and other wildlife.

Drawing 26 shows another new vessel that is needed for large ocean spills. The use of a Mobile (by water) Wildlife Cleaning Vessel 388 (and they can be on larger vessels 300 also) is also a new part and or vessel and or piece of equipment added to this oil collection process. This is a part of the response process, and this process also has it's own vessels just for that purpose. Instead of micro cleaning stations (also represented by number 15 in drawing 25 of this application), the larger vessels simply have larger cleaning stations 15 with bigger and more equipment. Drawing 26 shows a mobile cleaning vessel, and it shows a post rescued bird 155, a turtle 156, and a dolphin 157. These mobile cleaning stations would simply drive along the banks, shorelines, booming locations, and be on the lookout anywhere in the water for any animal that needs to be rescued or cleaned. Once cleaned the animal or bird, fish, etc. can either be temporarily stored in live well or cage type area especially suited for the different types of animals or birds in the area, and then taken to a place where they can be released, further cleaned, etc. Of course some of the vessels may be more specialized for cleaning certain types of birds or animals, storing them, etc. The vessels will be on call all the time and attached by radios, cell phones, etc. in case someone sees or hears of a bird, animal, reptile, etc. that needs cleaning. The vessels should have tanks full of clean water and several sink areas on board. The birds and animals are usually cleaned with Dawn soap or liquid dish soap. So there should be plenty of Dawn or liquid soap on board as well. Of course first aid products for people and animals, rubber gloves, plastic gloves, and maybe even food and water for animals, etc. are other products that might be on board as well. In this drawing the Scoop Pole 481 and Scoop Net attached 485 to help the response worker catch the wildlife is not visible, but many of such poles would likely be what is used to capture the soiled birds, etc. if they cannot just reach out and grab them. In no way does this drawing limit the Cleaning Station 15 to having to have or use one certain type of product or set-up, number of sinks, cages, live wells, etc. This drawing or description does not limit the Cleaning Station 15 to having anything other than being a mobile on the water cleaning station with crews out searching and rescuing birds, animals, and or wildlife of all kinds possible.

Drawing 27 will show another possible addition or option for the workings inside a interior tank 120 of a barge skimmer 107. This is option or design simply uses the addition of Air Bubble Frames, Pipes, etc. 132 (all types are represented by 132) anchored by blocks 714 (A) and (B), which pump air bubbles 133 from the bottom of the Barge Tank 120 so that air bubbles pumped under the oily water 102 helps to push the oil 101 to the top of the water for the purpose of providing extra assistance separating the oil from the water inside the tank; and or helps to make sure that the water which is to be pumped out of the lower parts of the barge tanks through hoses or drain pipes 150 will be cleaner, as well as that a greater concentration of oil would remain in the tank. This is one of many options for adding more equipment to Barge Skimmers so that after the oil is collected and contained inside the holding tanks, that there is a increase of efficiency in the storage of the oil; as well as having a additional process to clean the water which is to be returned to the ocean, river, lake, etc. Of course the higher concentration of oil collected and contained in the tanks allows for more oil to be collected per skimming operation, which improves efficiency. Also, the addition of equipment to clean the water improves the effectiveness of the skimming operation.

In no way does any of the drawings in this application limit any of the barge skimmers, netting, net frames, cleaning stations, air bubble barriers, etc. to just one single design or place of operation. The drawings and descriptions in this application are meant to provide examples of the equipment, plus they show and describe additional options for adding different types of equipment to the vessels to tailor their use or outcome; as well as to give a general description and or overall applicable demonstration of how the equipment might be used.

1. A new method of cleaning up oil spills consisting of several new inventions and or technologies, new to the oil spill response or clean-up industry that can be used in many combinations and with any other older or new response equipment, techniques, and or processes, and the new inventions are comprised of:
(a.) a new method of ‘Spotting’ the oil using drone helicopters 601 and planes/or jets 603, as well as using blimps 602, and by all having GPS ability;
(b.) a new method of skimming and collecting the oil from the water surface and or under the surface, as well as a method for containing and disposing the oil using many options sizes, shapes, and styles of Netting 405 along with Net Frames 401 which can be added to and or rigged to vessels 300 and trolled, trawled, pulled, etc.;
(c.) a method of skimming the oil from the water using Barge Skimmers 107 with a added and or shaped front end 111, Intake Area 110 designed for allowing Oil 101 to be funneled into the barge through the intake while the oil is then pumped or moves in pipes/hoses 150 from the intake to internal or external tanks 120, which contains the oil whereas by the natural properties of oil and water the Oil 101 rises to the top and the heavier Water 102 settles to the bottom, while having at least one drain at the bottom to let the clean water back out of the tank(s), thus creating the ability to increase oil, containment efficiency;
(d.) a method for rescuing wildlife by adding Mobile Wildlife Cleaning Vessels 388 which are in the Water 102 and can move about using their onboard Cleaning Stations 15 to clean, contain, and or rescue wildlife from the oil.
(d.) a method of creating a barrier in the water using Air Bubbles 133 and Air Bubble Creating Equipment 132 which can release air bubbles from under the surface of the oily water so to create a up-current which can block the oil 101 from entering a Bay, and or it can push the oil to the water surface for better or easier skimming, and or for aiding in separation of oil from the water inside a Barge Skimmer 107 Tank 120, etc.;
(g.) a method of measuring the layers of oil 101, oil water mixed 250, and water 102 inside the collection tanks of Barge Skimmers 107 and or Vessels containing oil by using the see-through Oil/Water Checking Tube 802, which contains a airtight cap having a optional hose 150 connected to a valve 804 and optional pump 803.

2. A new invention of'a more efficient water going oil skimming vessel, called a Barge Skimmer 107, that is made up of,
(a.) a Front End 111 rigging or attachment connected to the front of the barge, protruding from the front end, having a opening or Intake Area 110 for collecting oil and or skimming oil, whereby the opening is under, right at, and above the water line so the oil can simply come into the intake area,
(b.) a Front End 111 having a oil Intake Area 110 with one or more openings, where when skimming, anchored and or positioned against the current, etc. the oil floating on the water surface can be funneled into the Intake Area 110, which is open,
(c.) a open Intake Area 110 within the protruding front end attachment, having many design options for using different types of equipment and techniques for skimming, collecting, and or suctioning the oil floating and or funneled into the Intake Area 110, and then letting it move by gravity or by pumping it to a area where either internal or external hoses/pipes 150 will take the skimmed oil from the Intake Area 110 to the larger Barge Collection Tank(s) 120,
(d.) a Intake Area which uses any one, or combinations of, the following options to take-in and or collect the oil that is coming into and or being funneled into the Intake area, so to then transfer or pump the oil from the intake area into the larger barge collection tanks 120, : vacuum/pump equipment 104 (see example options in drawings 15 and 21), spill-over pipes near a bulkhead 158 (see example option in drawing 20), conveyor belt system 510 (see example in drawing 17), a front end with a hoist or lift 112 (see drawing 19), and or using floating suction pumps commonly used in the industry, etc.,
(e.) having internal or external pipes/hoses 150, whereby the incoming oil, once inside the intake areas and into or near the pipes or hoses 150, can either use gravity or Vacuum Pumps so to move the oil from the Intake Area 110 to one or more of the larger internal and or external collection Tank(s) 120 inside the Barge Skimmer 107,
(f.) having one or more large internal and or external Barge Collection Tanks 120 for holding and or containing the oil that is collected and or skimmed,
(g.) having one or more internal and or external Barge Collection Tanks 120 where the oil is stored, but also where a water and or oil cleaning process can begin by taking advantage of the natural properties of oil and water whereby the lighter oil 101 rises to the top and the heavier water 102 goes to the bottom (see drawing 11),
(h.) having at least one Drain 151 connected to a pipe/hose 150 (doesn't have to be in the internal plumbing) that extends down to the bottom of the Collection Tanks, so that when the plug is opened or removed and the Drain is opened, water from the bottom of the tank is forced out, while the tank fills with just oil (see drawing 11 for a example),
(i.) having a large deck area with the option of adding additional equipment for tailoring the Barge Skimmer 107 for efficiency, and or to meet a desired outcomes for oil containment, in terms of concentration of oil versus water contained, as well as for the cleanliness of the water pumped overboard after collected initially, made possible by using any combination of additional equipment such as: Oil Centrifuge equipment 105, Vacuum Pump 104, hoses or pipes 150 to connect the equipment and or tanks or drains, Electric Generators 106, Air Bubble Pipe Equipment 132, Air Compressors 271, Windmill Aeration equipment 113, Sprayers 261, Bio Products and or Dispersant 262, etc.
(j.) having the options of adding propulsion systems to the Barges Skimmers 107 and or using tugboats, towboats, etc. to push or pull them through the water;
(k.) having the option of pulling the Barge Skimmers 107 through the water using towboat/tugboat/vessels 300 through the water using booms 777 that act as a funnel so to skim and or funnel a lot more oil from a much wider area into the mouth of the Front End 111 and or Intake Area 110;
(l.) having the ability to make the Barge Skimmers in different sizes and or scales so that they can be made and or tailored for use in many area, especially shallow waters and or environmentally sensitive areas,

3. A new invention called a Bubble Barrier System, which is a blockade to keep oil from entering certain areas of the water, for assisting in skimming, suction, and or collection operations, as well as to provide oxygen to the water in areas where a spill has occurred, which consists of,
(a.) a object, usually a tube, referred to as a Air Bubble Pipe 132 in this application, and having the option of being made from many different materials, with an examples being from: steel, aluminum, titanium, rubber, plastic, and or PVC, etc.
(b.) with the said Air Bubble Pipe 132 being capped at both ends and airtight but having a hose 150 attached and through to the inside of the cap at one or both sides, and extending from the Air Bubble Pipe 132 to a air compressor 271, air pump, windmill 113 aeration device, etc.
(c.) having small holes drilled through the pipe, into the top of one side, and lengthwise throughout the pipe,
(d.) having a air producing device, such as a air compressor, air pump, windmill, etc. creating air pressure and attached to the other end of the hose that is attached to the tube on the opposite end,
(e.) using the compressor 271, windmill 113, air pump, etc. to produce air pressure and or force the air through the hose connected to the Bubble Pipe 132, and into the pipe where the air escapes through the holes in the pipe producing many air bubbles 133,
(f.) having one or both ends weighted down, and or anchored 714 in some way so that the system can be lowered below the water line or surface, and in many cases set so that it is positioned on the floor of the body of water where the Bubble Barrier is to be placed or used,
(g.) as the air escapes from the holes in the pipes, the escaping air bubbles 133 form a barrier which rises to the top of the water producing a up-current which opposes any incoming surface current so that whatever is floating in that direction is stopped,
(h.) the escaping air bubbles 133 from the below the water line also can create a up-current from under the water surface and from underneath incoming oil so to force the oil to the top of the water so to make skimming easier,
(i.) the air bubbles 133 being released in a heavily oiled area can also provide much needed oxygen to the water to assist and improve living conditions for fish and aquatic life in areas where a oil has leaked or been spilled,
(j.) and having many options for various formations and or design, such as one grid like formation where many Air Bubble Pipes and or Tubes 132 can be connected together with one compressor and one hose 150 connected and providing air to all the Tubes or Pipes 132, or where loose tentacle like rubber tubes with holes extend upward to let the air escape, etc.

4. A new invention of a Netting 405 and Net Frame 401 skimming system, consisting of,
(a.) Netting 405 weaved, stitched, made, and or constructed with a porous pattern whereby water 102 but not oil 101 can pass through,
(b.) Netting 405 made from a material such as: wire screen such as that on a screen door, a mesh like material similar to that which lawn furniture is made from, nylon, plastic, and or any other strong and durable fabric or material which has the porous weaving pattern so that when trawled or trolled in a Net Frame 401 it collects the oil and lets the water pass through, and that can hold up to the amount of oil that it can collect,
(c.) Net bags or the Netting 405 made to fit certain sized frames or Net Frames 401, so that they can be used in a similar way as trash bags are used by attaching to a Net Frame being open at one side and closed at the other (like a bag),
(d.) Having a Net Frame 401, which holds the nets 405 open so that they can be trolled or trawled through the water while connected to a boom and or hoist 402 or rigging similar to what a shrimp boat or crab fishing boat would use,
(e.) having a Net Frame 401 made from a durable and strong material such as, PVC, Steel, aluminum, titanium, carbon, fiberglass, Plexiglas, etc. and shaped in many optional ways so to hold a attached Net 405 open at one end so that oil 101 can enter when skimming, and the Net Frame can either be open or closed at the other end,
(f.) having loops or hooks on the front and open end of the Net Frame 401 where the Nets 405 and or Net bags (also 405) can attach to the Net Frames for trolling, trawling, skimming, etc.,
(g.) having a Net and or Net Bag 405 with loops at the open end where the Net can attach to the Net Frames,
(h.) having the option of a drawstring on the Net Bags 405 for pulling or cinching the Net or Net bag 405 shut once filled with oil,
(i.) having a Net Frame in many shapes, for example the shape of a box or cage such as one that resembles a crab trap that is roughly six foot by six foot, that holds a Net bag 405, can attach to the Hoist 402 of a shrimp or fishing vessel 300 (see drawing 5 for a example), can have one or more on each side of the vessel, with a Net Bag 405 inside and trolling thus skimming for oil,
(j.) having the option, once the bag is filled, to have the bag suctioned or vacuumed out, and or the option of exchanging the old bag for a new one by pulling the old Net Bag 405 out of the net frame 401 by grabbing the drawstring, pulling the bag off, cinching the bag shut, and disposing in a way similar to a trash bag by either dragging it behind the vessel to a collection area for dumping or burning, and or hoisting into a tank, etc.
(h.) having the option of taking a old bag off the net frame and putting new ones on every time the bags are filled.
(i.) having the option of trawling or trolling with super large Nets and or Net Bags 405 having to pull the Net with two or more vessels 300 to either collect oil on the surface or even dispersed oil columns hovering at any depth below the water surface, etc.
